(19) United States
(12) Patent Application Publication
(10) Pub. No.: US 2003/0028413 A1
(43) Pub. Date: Feb. 6, 2003

(54) System and method for evaluating strategic business alliances

(76) Inventors: Storn White, San Francisco, CA (US); Satomi Degami, Oakland, CA (US)

Correspondence Address: Terrance A. Meador, Gray Cary Ware & Freidenrich, 401 B Street, Suite 1700, San Diego, CA, 92101-4297, US

(21) Appl. No.: 09/821,482

(22) Filed: Mar. 29, 2001

(51) Int. Cl. G06F 17/60

(52) U.S. Cl. 705/10

(57) ABSTRACT

A computer-implemented system is capable of evaluating the net present value (NPV) of a product development program having a number of strategic alliance components, such as guaranteed research payments, royalty payments, milestone payments, and the like. The evaluation system is iterative in nature—it calculates an overall NPV for each simulation iteration and generates statistical distributions that reflect the mean and median NPVs. The evaluation system allows the end user to designate specific deal structure terms prior to the simulation. Alternatively, the evaluation system can generate default or suggested development and/or sales assumptions based on historical or empirical clinical data related to actual product development programs.

### FIELD OF THE INVENTION

The present invention relates generally to a software-based analytical tool. More particularly, the present invention relates to a software-based system that evaluates the economic value of strategic alliances that foster the development of drugs and other products associated with the biotechnology industry.

### BACKGROLND OF THE INVENTION

The development of a pharmaceutical drug can be a costly and time consuming process. For example, in the United States, the development of a commercial drug typically progresses through at least the following stages: preclinical testing (which may include the discovery of a new drug having a desired effect and the validation of the new drug); the filing of an Investigational New Drug (IND) application with the Food and Drug Administration (FDA); Phase I clinical trials (toxicity screening); Phase II clinical trials; Phase III clinical trials; the filing of a New Drug Application (NDA) with the FDA; and FDA approval. The success rate of any of these developmental milestones, the time duration of each developmental stage, and the cost associated with each developmental stage may depend on any number of technological and economic variables. In addition, the successful development of a pharmaceutical product may involve the participation of any number of entities, e.g., research and development (R&D) companies, universities, pharmaceutical companies, government agencies, medical facilities, and the like. Consequently, the development process for a pharmaceutical product can be complicated from both a technology perspective and an economic perspective.

Strategic alliances are commonplace in the biotechnology industry. For example, R&D efforts may be supported by one or more pharmaceutical companies or government agencies. Financial support during the developmental stages may be provided in various forms, e.g., milestone payments, sponsored research, or expense reimbursements. In addition, strategic partners may agree to share the post-commercial proceeds generated through sales of the developed product. The complexity of such alliances, variations in product sales figures, unknown success and failure rates for any given developmental stage, indeterminate time durations for the developmental stages, and other variable economic and technological factors make it difficult for industry participants to accurately forecast the value of a proposed strategic alliance.

A non-iterative economic analysis may not accurately model the probabilistic functions that govern the development of pharmaceutical drugs in a real world context. In addition, rudimentary computer simulation tools may not utilize empirical data associated with the development of (or failed attempt to develop) actual products. Without such empirical data, conventional techniques may fail to accurately forecast the likelihood of success of a proposed strategic alliance.

### BRIEF SUMMARY OF THE INVENTION

The preferred embodiment of the present invention is capable of analyzing strategic alliances and “deals” in the context of the development of a typical biotechnology or pharmaceutical product. The preferred embodiment of the invention may be implemented as a software application or a suite of software applications executed by one or more computer systems. The software simulates repeated attempts at developing a drug according to probabilistic functions that govern the development time and commercial success of the drug. For each attempt, the evaluation system tracks the cash flowing in and out of the project as expenses are paid, revenues are received, and partnership obligations are fulfilled. Each cash flow is then reduced to a net present value (NPV). A distribution of NPVs grows as the simulation repeats; this distribution represents the value of a partnered drug development program. In a practical embodiment, an end user can enter details of the strategic alliance, development assumptions, and sales assumptions related to the proposed development program (or the end user can obtain empirical data relating to development costs, development timelines, sales data, or historical alliance terms from a server database). The system analyzes and processes the data and generates one or more indicators that represent the likelihood that the proposed deal will add value to the participating company.

The above and other aspects of the present invention may be carried out in one form by a computerized method for evaluating the value of a proposed development program for a product. The method performs the following tasks: obtaining a set of development cost assumptions for the proposed development program; repeatedly calculating an NPV for the proposed development program to obtain a plurality of NPVs; and generating a statistical representation of the plurality of NPVs. In this method, each of the NPVs is calculated in response to the set of development cost assumptions and in response to at least one probabilistic function.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a schematic representation of an alliance evaluation system that may incorporate the techniques of the present invention;

FIGS. 2-14 are example screen shots of a graphical user interface generated by an alliance evaluation system;

FIG. 15 is a flow diagram of an alliance evaluation process;

FIG. 16 is a flow diagram of a process for generating development timelines;

FIG. 17 is a flow diagram of a process for calculating an unpartnered net present value (NPV);

FIG. 18 is a graph of an example NPV distribution for a proposed development program;

FIG. 19 depicts example graphs corresponding to different NPV distributions for a proposed development program;

FIG. 20 is a flow diagram of a process for handling guaranteed payments;

FIG. 21 is a flow diagram of a process for handling sponsored research terms;

FIG. 22 is a flow diagram of a process for handling milestone payments;

FIG. 23 is a flow diagram of a process for handling expense reimbursements;

FIG. 24 is a flow diagram of a process for handling royalty payments;

FIG. 25 is a flow diagram of a process for handling profit splitting terms; and

FIG. 26 is a flow diagram of a process for handling supply agreement terms.

### DETAILED DESCRIPTION OF A PREFERRED EMBODIMENT

The present invention may be described herein in terms of functional block components and various processing steps. It should be appreciated that such functional blocks may be realized by any number of hardware components configured to perform the specified functions. For example, the present invention may employ various integrated circuit components, e.g., memory elements, digital signal processing elements, logic elements, look-up tables, and the like, which may carry out a variety of functions under the control of one or more microprocessors or other control devices. In addition, those skilled in the art will appreciate that the present invention may be practiced in conjunction with any number of data transmission and network protocols and that the system described herein is merely one exemplary application for the invention.

It should be appreciated that the particular implementation shown and described herein is illustrative of the invention and its best mode and is not intended to otherwise limit the scope of the invention in any way. Indeed, for the sake of brevity, conventional techniques for data processing, data transmission, software design, and other functional aspects of the system (and the individual operating components of the system) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical embodiment.

System Overview

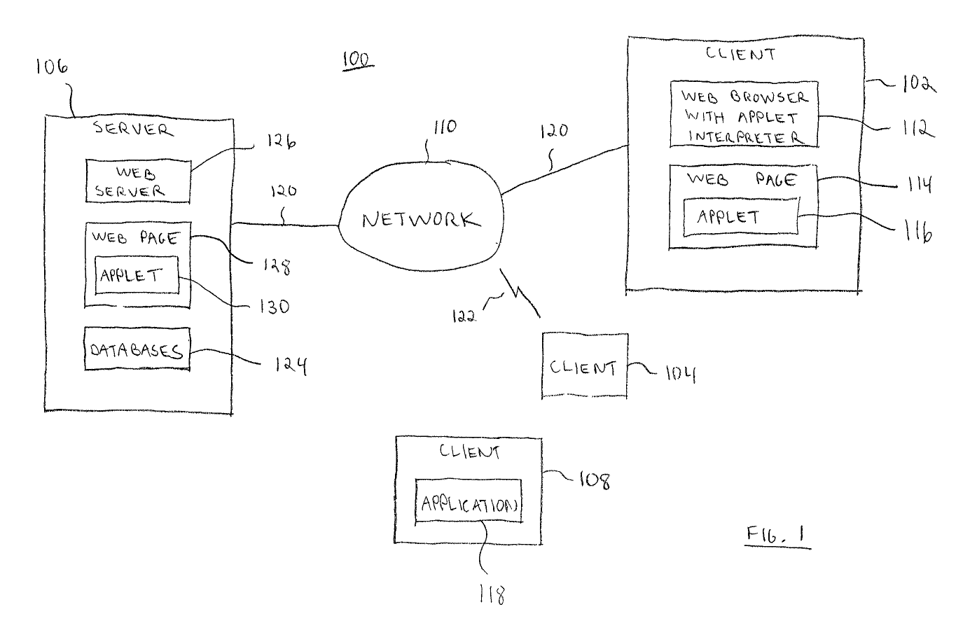

The techniques of the present invention are preferably carried out in the context of a network data communication system (however, a number of the features described herein can be carried out by a stand-alone computer system having no network connectivity). FIG. 1 is a schematic representation of an alliance evaluation system 100 in which the techniques of the present invention may be implemented. Evaluation system 100 is suitably configured to deliver HTML documents, data, control commands, software programs, Java applets, and the like, from at least one server device (or system) to any number of remote end user client devices. Evaluation system 100 is depicted in a generalized manner to reflect its flexible nature and ability to cooperate with any number of different communication systems, service providers, and end user devices. Although this description focuses on the analysis of strategic alliances and product development scenarios in the biotechnology and pharmaceutical drug industry, the techniques of the present invention are not so limited. Indeed, the concepts described herein may be equivalently applied to the processing, analysis, and/or evaluation of any type of business alliance, licensing proposal, intellectual property development plan, business plan, or the like.

Evaluation system 100 may include any number of client devices 102, 104 that communicate with at least one system server 106. In addition (or alternatively), any number of client devices 108 may be configured as a stand-alone device that need not communicate with system server 106. In a typical deployment, system server 106 is maintained or operated by the entity that makes evaluation system 100 available to end users of the various client devices.

As used herein, a “client device” is any device or combination of devices capable of providing information to an end user of evaluation system 100. For example, any of client devices 102, 104, 108 may be a personal computer, an Internet-ready appliance, a wireless telephone, a personal digital assistant (PDA), a calculator, or the like. The client devices may be configured in accordance with any number of conventional platforms, while using various known operating systems (OSs). For example, in a typical system, the client device is a personal computer running the Windows OS or the Macintosh OS.

In accordance with the preferred embodiment, the client devices communicate with system server 106 via a network 110, e.g., a local area network (LAN), a wide area network (WAN), the Internet, or the like. Although not shown in FIG. 1, network 110 may include any number of cooperating wireless and/or wired network elements, e.g., switches, routers, hubs, wireless base stations, gateways, and the like. It should be appreciated that the present invention need not utilize network 110, e.g., any number of client devices can be connected (directly or wirelessly) to system server 106. In the preferred embodiment, network 110 is the Internet and the individual client devices 102, 104 are configured to establish connectivity with the Internet using conventional application programs and conventional data communication protocols (any stand-alone client device, e.g., client device 108, need not have such connectivity to network 110). For example, client devices 102, 104 may be configured to connect to the Internet via an internet service provider (ISP) (not shown in FIG. 1).

Client device 102, which is illustrative of any client device that communicates with system server 106 via network 110, preferably includes a web browser 112 that is capable of presenting web pages (such as web page 114) to the user of client device 102. Web browser 112 may be configured in a conventional manner to allow the user to view HTML documents and web pages transmitted via TCP/IP and other known techniques and protocols utilized in the context of Internet communications. A number of commercially available web browser applications may be suitable for use in connection with client device 102, e.g., INTERNET EXPLORER or NETSCAPE NAVIGATOR. Internet service providers, such as AMERICA ONLINE, may provide suitable web browser applications to subscribers; such web browser applications may also be compatible for use in the context of the present invention. Notably, most personal computers loaded with standard operating systems and common software packages need not be modified to support the features of the present invention, i.e., a conventional personal computer may be used for client device 102.

Client device 102 (in particular, web browser 112) preferably includes a suitable applet interpreter configured to receive code that represents an applet 116. The applet interpreter is also configured to convert the received code into a language compatible with client device 102. For example, applet 116 may be a Java applet and web browser 112 may include a Java interpreter that enables client device 102 to run the Java applet. In the preferred embodiment, the client-side software component of evaluation system 100 is realized as a Java applet associated with web page 114. In accordance with conventional techniques, the applet 116 runs locally when the end user selects web page 114.

In contrast to the Java-enabled implementation utilized by client device 102, stand-alone client device 108 need not rely on an applet contained in an HTML document or web page. Rather, client device 108 need only execute a suitable local client application 118. Local client application 118 may be stored at client device 108 as any suitably formatted executable program, including a local Java applet. In a practical embodiment, local client application 118 can be launched by the end user of client device 108.

In a practical embodiment, client devices 102, 104 and system server 106 are connected to network 110 through various communication links 120, 122. Communication link 120 represents a wired connection between client device 102 and network 110, while communication link 122 represents a wireless connection between client device 104 and network 110. As used herein, a “communication link” may refer to the medium or channel of communication, in addition to the protocol used to carry out communication over the link. In general, a communication link may include, but is not limited to, a telephone line, a modem connection, an Internet connection, an Integrated Services Digital Network (ISDN) connection, an Asynchronous Transfer Mode (ATM) connection, a frame relay connection, an Ethernet connection, a Gigabit Ethernet connection, a Fibre Channel connection, a coaxial connection, a fiber optic connection, satellite connections (e.g., Digital Satellite Services), wireless connections, radio frequency (RF) connections, electromagnetic links, two-way paging connections, and combinations thereof.

Communication links 120, 122 may be suitably configured in accordance with the particular communication technologies and/or data transmission protocols associated with the given client device. For example, although a communication link 120, 122 preferably utilizes broadband data transmission techniques and/or the TCP/IP suite of protocols, the link could employ NetBIOS, NetBEUI, data link control (DLC), AppleTalk, or a combination thereof. Communication links 120, 122 may be established for continuous communication and data updating or for intermittent communication, depending upon the infrastructure.

A “server” is often defined as a computing device or system configured to perform any number of functions and operations associated with the management, processing, retrieval, and/or delivery of data, particularly in a network environment. Alternatively, a “server” may refer to software that performs various processes, methods, and/or techniques. As used herein, “system server” generally refers to a computing architecture that processes data, provides HTML documents, communicates with client devices, and otherwise functions as described in more detail below. As in most commercially available general purpose servers, a practical system server 106 may be configured to run on any suitable operating system such as UNIX, LINUX, the APPLE MACINTOSH OS, or any variant of MICROSOFT WINDOWS, and it may employ any number of microprocessor devices, e.g., the PENTIUM family of processors by INTEL or the processor devices commercially available from ADVANCED MICRO DEVICES, IBM, SUN MICROSYSTEMS, or MOTOROLA.

The system server 106 preferably includes and/or communicates with one or more databases 124 or data sources, which may be configured in accordance with conventional techniques. In the context of the present invention, the databases 124 may contain empirical test data, example parameters (e.g., alliance structure components, development cost assumptions, sales assumptions, or the like), historical evaluation results, development timeline data, historical alliance terms taken from actual real world alliances, historical sales data, clinical trials data, and/or other information related to evaluation system 100. The manner in which evaluation system 100 utilizes the data contained in databases 124 is described in more detail below. A given database 124 may be integral to system server 106, it may be a distinct component maintained at the service site associated with system server 106, or it may be maintained by a third party unrelated to the entity responsible for maintaining system server 106. Accordingly, (although not depicted in FIG. 1) database 124 may be configured to communicate with system server 106 over a direct communication link and/or via network 110 using an indirect communication link.

System server 106 preferably includes a web server 126, which may be configured in a conventional manner to provide web navigation capabilities in connection with the Internet. In a practical embodiment, web server 126 may employ a commercially available application such as APACHE, MICROSOFT IIS, NETSCAPE, or the like. Web server 126 may operate to manage, process, and deliver HTML documents (such as a web page 128) in response to requests from client device 102, 104. As described above, web page 128 may include a suitable applet (e.g., a Java applet) 130 that is downloaded by the respective client device 102, 104 for local execution.

In accordance with conventional techniques, the server and client processors communicate with system memory (e.g., a suitable amount of random access memory), and an appropriate amount of storage or “permanent” memory. The permanent memory may include one or more hard disks, floppy disks, CD-ROM, DVD-ROM, magnetic tape, removable media, solid state memory devices, or combinations thereof. In accordance with known techniques, the OS programs, the server application programs, and a number of client application programs reside in the respective permanent memories and portions thereof may be loaded into the respective system memories during operation. In accordance with the practices of persons skilled in the art of computer programming, the present invention is described below with reference to symbolic representations of operations that may be performed by system server 106 or client devices 102, 104, 108. Such operations are sometimes referred to as being computer-executed. It will be appreciated that operations that are symbolically represented include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

When implemented in software, various elements of the present invention (which may reside at client devices 102, 104, 108 and/or at the system server 106) are essentially the program code segments that perform the various tasks. The program code segments can be stored in a computer-readable medium or transmitted by a computer data signal embodied in a carrier wave over a transmission medium or communication path. The “computer-readable medium” or “machine-readable medium” may include any medium that can store or transfer information. Examples of the computer-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The program code segments may be downloaded via computer networks such as the Internet, an intranet, a LAN, or the like.

Graphical User Interface

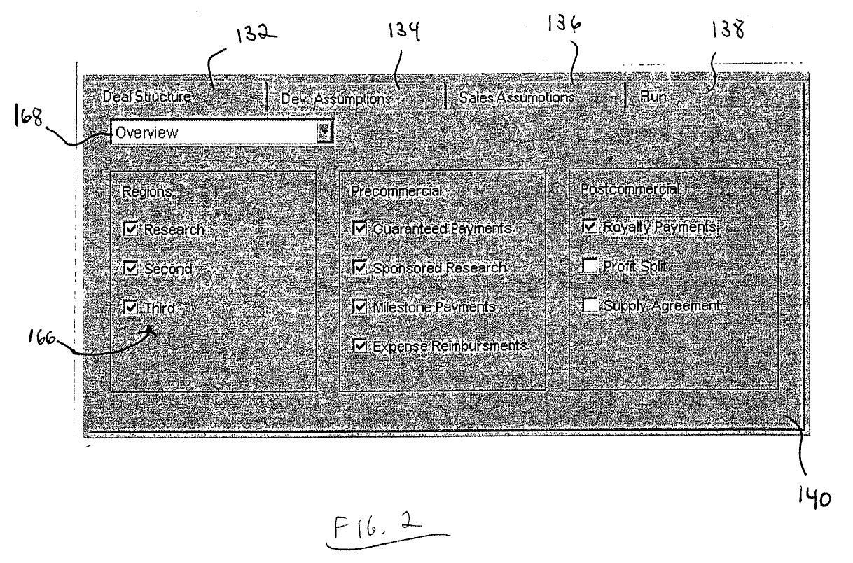

In the preferred practical embodiment, evaluation system 100 renders a graphical user interface (GUI) on the respective client device; the GUI may include any number of data entry fields, electronic worksheets, selection menus, control features, and other elements. FIGS. 2-14 illustrate example panels and worksheets that may be generated by evaluation system 100 (the particular format, layout, and labeling employed by the GUI, and the specific types and amount of data entry fields contained on the GUI, can vary from system to system).

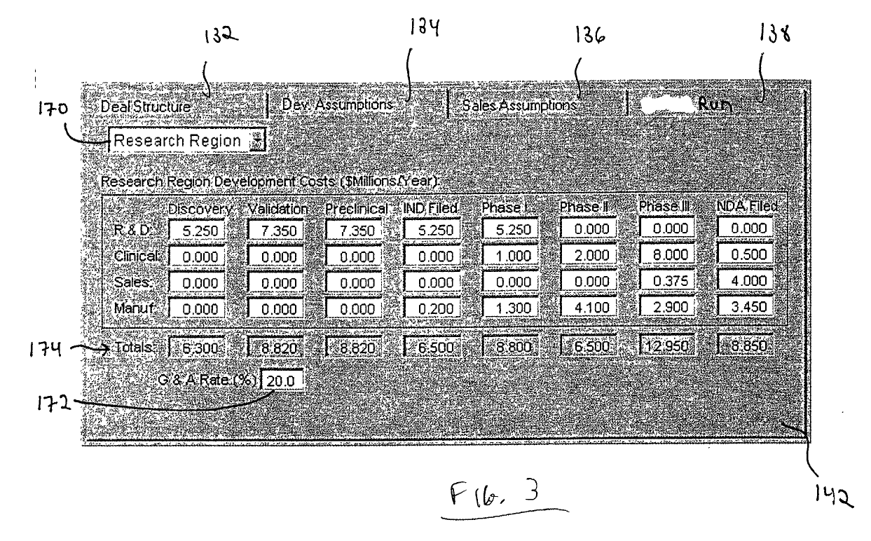

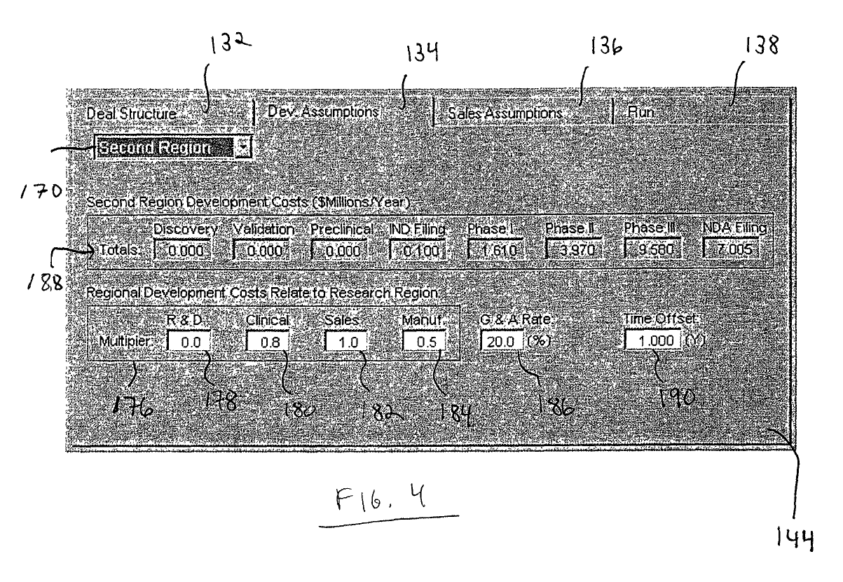

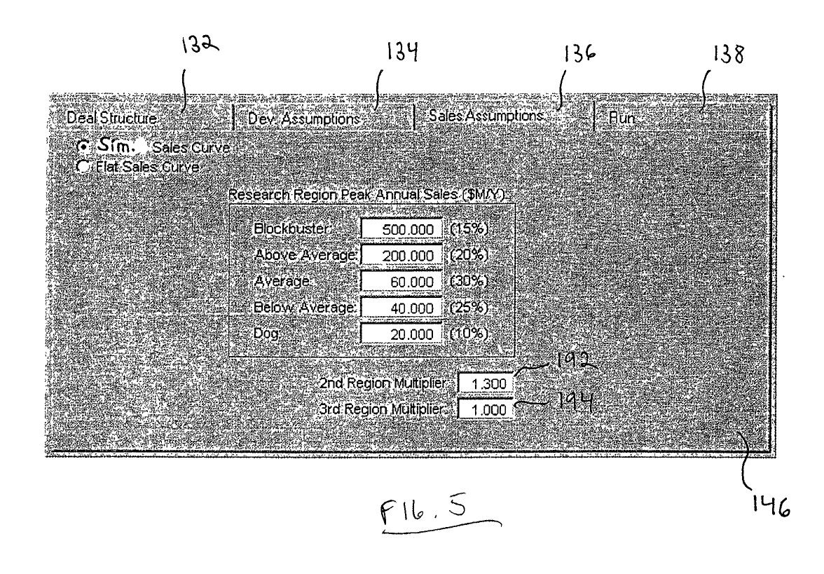

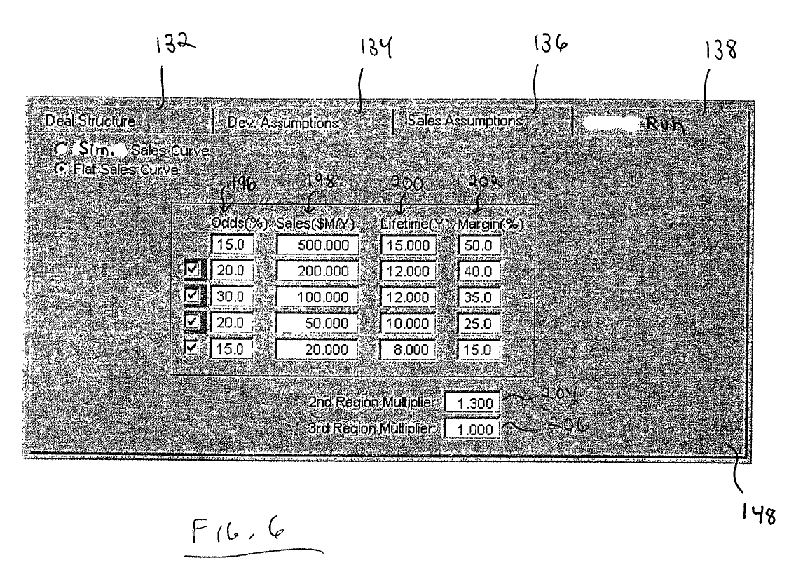

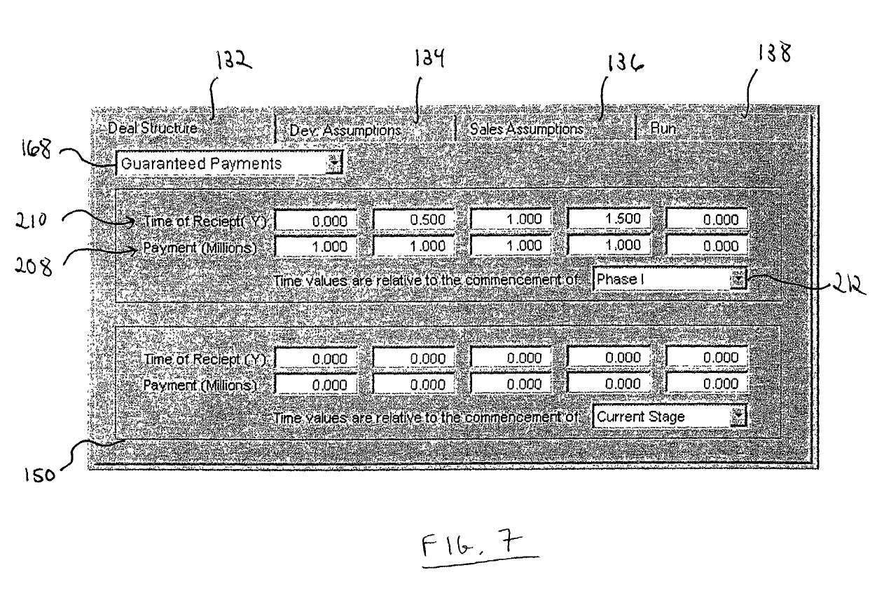

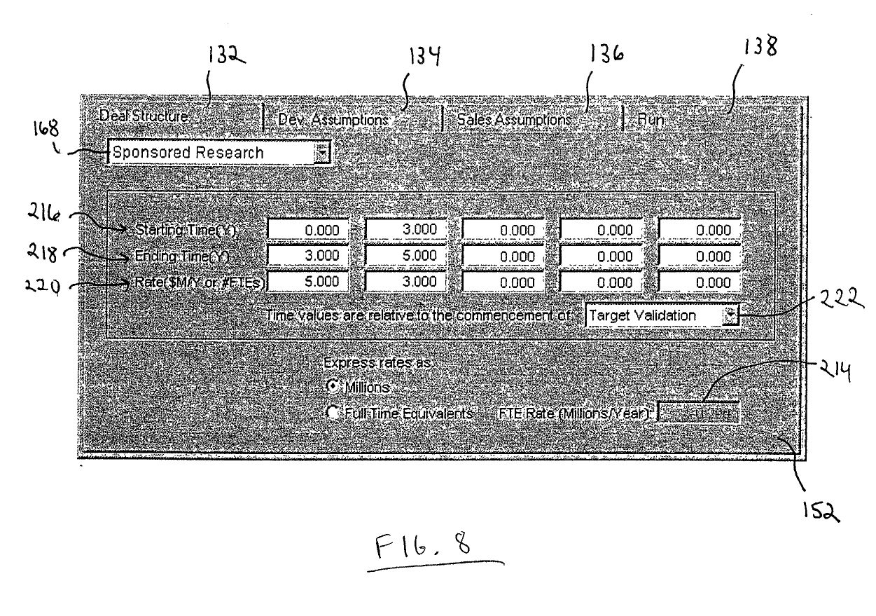

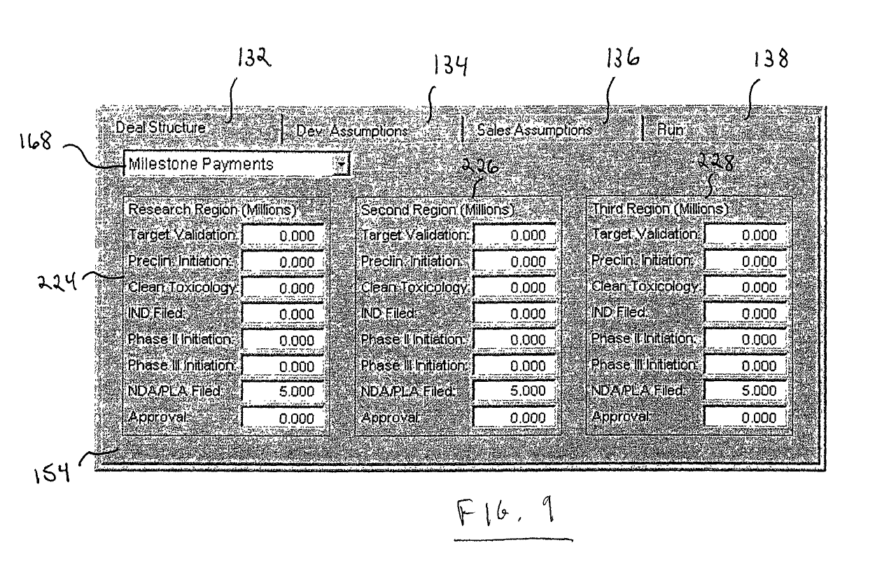

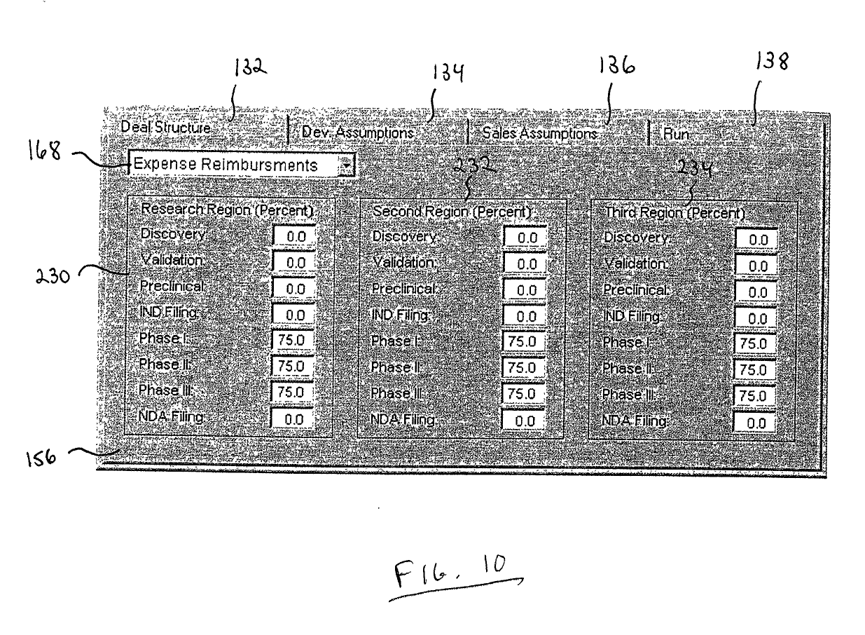

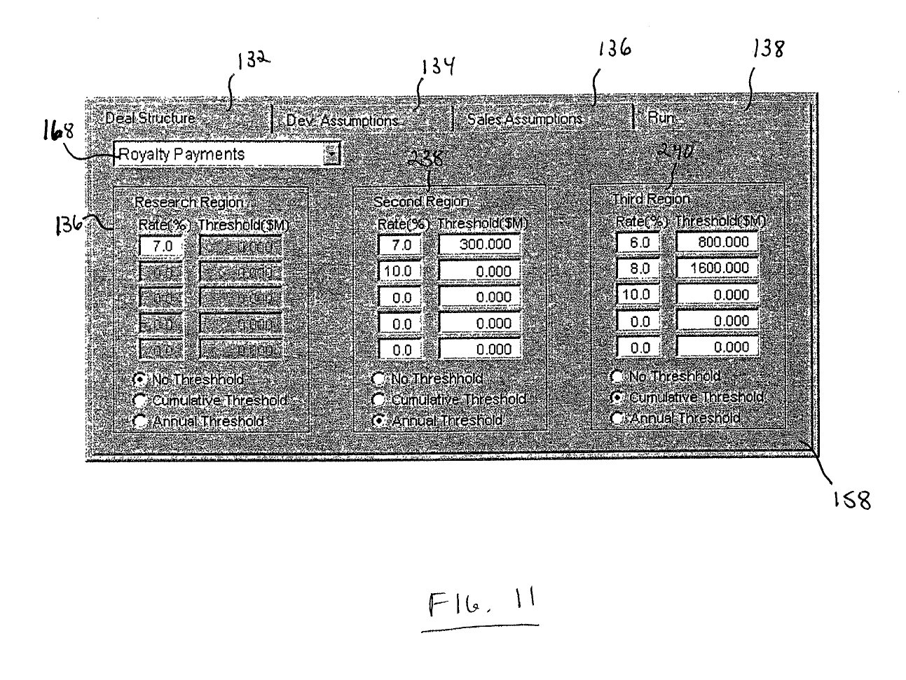

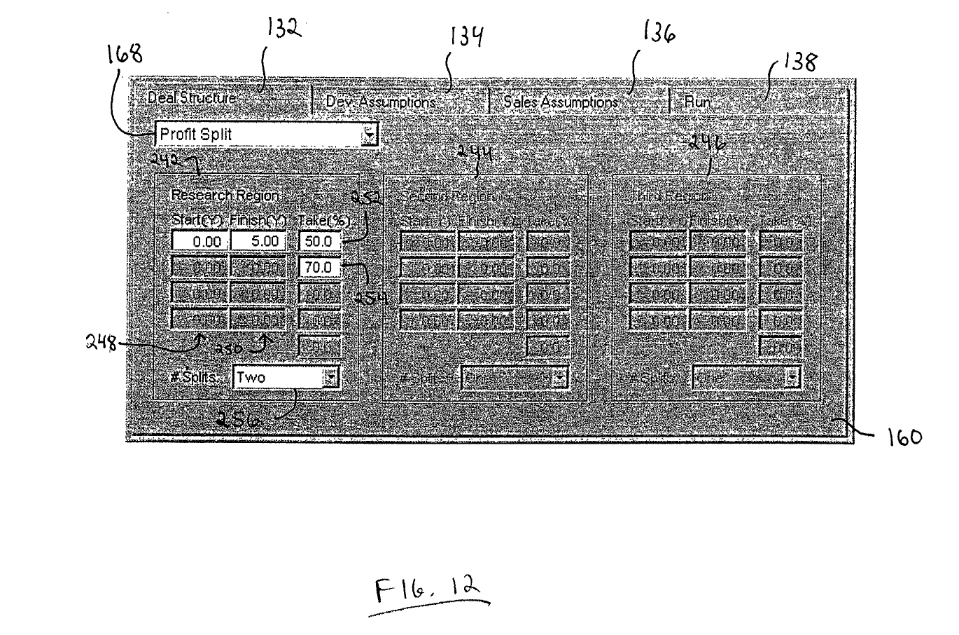

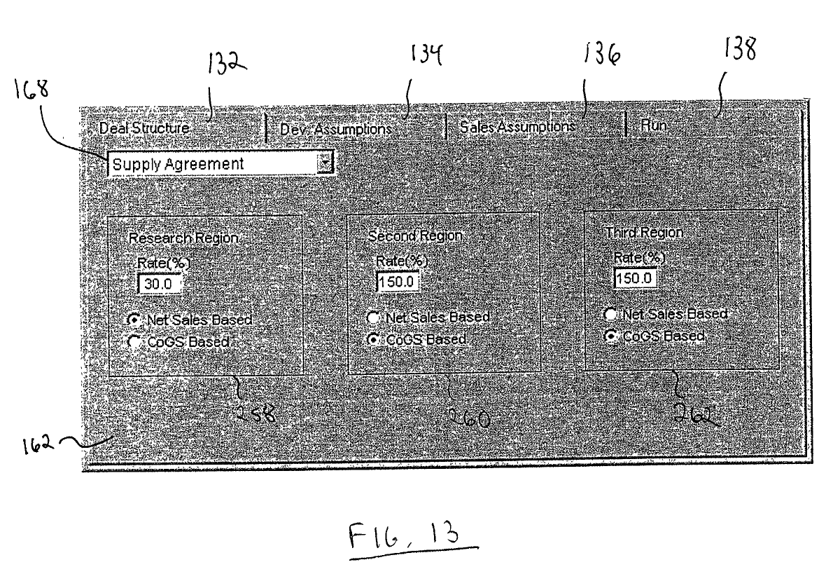

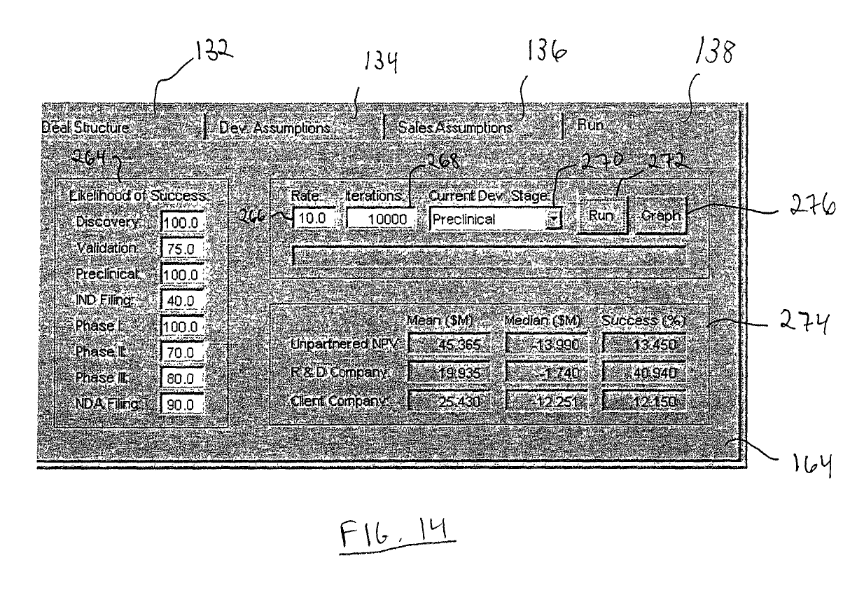

As shown in FIGS. 2-14, the various features of the GUI are accessible via four primary tabs: a Deal Structure tab 132, a Development Assumptions tab 134, a Sales Assumptions tab 136, and a Run tab 138. Each of these primary tabs has one or more corresponding worksheets associated therewith; a given worksheet is displayed when the user selects the corresponding tab. In this regard, FIG. 2 depicts a Deal Overview worksheet 140 that is accessible via Deal Structure tab 132, FIG. 3 depicts a Research Region Development Assumptions worksheet 142 that is accessible via Development Assumptions tab 134, FIG. 4 depicts a Second Region Development Assumptions worksheet 144 that is accessible via Development Assumptions tab 134, FIG. 5 depicts a Simulated Sales worksheet 146 that is accessible via Sales Assumptions tab 136, FIG. 6 depicts a Flat Sales worksheet 148 that is accessible via Sales Assumptions tab 136, FIG. 7 depicts a Guaranteed Payments worksheet 150 that is accessible via Deal Structure tab 132, FIG. 8 depicts a Sponsored Research worksheet 152 that is accessible via Deal Structure tab 132, FIG. 9 depicts a Milestone Payments worksheet 154 that is accessible via Deal Structure tab 132, FIG. 10 depicts an Expense Reimbursement worksheet 156 that is accessible via Deal Structure tab 132, FIG. 11 depicts a Royalty Payments worksheet 158 that is accessible via Deal Structure tab 132, FIG. 12 depicts a Profit Split worksheet 160 that is accessible via Deal Structure tab 132, FIG. 13 depicts a Supply Agreement worksheet 162 that is accessible via Deal Structure tab 132, and FIG. 14 depicts a Run worksheet 164 that is accessible via Run tab 138.

Referring to FIG. 2, Deal Overview worksheet 140 includes a number of selectable checkboxes that allow the user to customize the current alliance structure. For example, Deal Overview worksheet 140 preferably includes a plurality of regional checkboxes 166 corresponding to different geographical regions. Although the number of different regions need not be limited, the example embodiment includes research, second, and third regions. The research region, which may be selected by evaluation system 100 by default, represents a primary geographical region in which the product development and/or sales will occur. For example, the research region may represent a country such as the United States, a geographical region such as Europe, or a state or province within a country. The secondary and third regions represent other geographical regions in which the product development and/or sales may also occur. For example, a proposed development program may include clinical trials in any number of countries and a commercial product may be sold throughout the world. Regional checkboxes 166 allow the user to indicate that more than one region should be considered by evaluation system 100.

A number of precommercial and postcommercial deal structure components may also be selected via corresponding checkboxes rendered on Deal Overview worksheet 140. The precommercial deal structure components may include, without limitation, guaranteed payments, sponsored research, milestone payments, and expense reimbursements. The postcommercial deal structure components may include, without limitation, royalty payments, profit splits, and supply agreements. As used herein, precommercial deal structure components represent characteristics of the alliance structure that are applicable during the developmental stages of the product, while postcommercial deal structure components represent characteristics of the alliance structure that are applicable after the product has been developed and/or during commercial exploitation of the product. Evaluation system 100 may be suitably configured to accommodate any number of additional or alternative deal structure components (whether designated as precommercial, postcommercial, or otherwise). For example, evaluation system 100 may accommodate loans from the client entity to the R&D entity or purchases of equity in the R&D entity by the client entity.

In practice, the user need not select any deal structure components before running the evaluation. In such a case, the resulting evaluation will represent an unpartnered scenario in which one entity or company develops and sells the product. However, most realistic drug development programs involve at least one R&D entity (responsible for the development of the product) and at least one other entity (usually responsible for the commercialization of the product). Consequently, the evaluation system 100 is configured to allow the user to select any number of the precommercial and/or any number of the postcommercial deal structure components. Deal Structure tab 132 may be associated with a selection menu 168 having an “Overview” entry that, when selected by the user, returns the GUI to Deal Overview worksheet 140. Evaluation system 100 displays additional entries in selection menu 168 corresponding to the selection of deal structure components. Selection menu 168 functions as a pulldown menu; the selectable entries are displayed and, evaluation system 100 displays a worksheet (these individual worksheets are described in detail below) corresponding to the selection of one of the displayed entries. For the example Deal Overview worksheet 140 shown in FIG. 2, selection menu 168 includes entries corresponding to guaranteed payments, sponsored research, milestone payments, expense reimbursements, and royalty payments.

Referring to FIG. 3, Research Region Development Assumptions worksheet 142 is displayed when the “Research Region” entry is highlighted in a selection menu 170. Selection menu 170 may also include a “Second Region” entry and a “Third Region” entry that represent corresponding Development Assumptions worksheets for those regions. As shown in FIG. 3, Research Region Development Assumptions worksheet 142 may include data entry fields that allow the user to enter development costs for any number of product development stages. In the example shown herein, the product development program is divided into eight different stages: discovery, validation, preclinical, IND filed, Phase I, Phase II, Phase III, and NDA filed. Evaluation system 100 is not limited to these (or any) development stages; these eight stages merely represent the typical development of a pharmaceutical drug. Alternatively, evaluation system 100 may separate a development program into any number of predetermined or user-selectable stages (more or less than eight). For example, evaluation system 100 may be suitably configured to enable the user to designate the number of development stages and/or the characteristics associated with each development stage.

Each development stage can be associated with one or more different types of expenses or costs. For example, evaluation system 100 separates developmental costs into the following four categories: R&D, clinical, sales, and manufacturing (alternatively, evaluation system 100 may separate such developmental costs into more or less categories). As shown in FIG. 3, each of the eight development stages includes four data entry fields corresponding to the four cost categories. In this respect, Research Region Development Assumptions worksheet 142 identifies the precommercial costs and expenses related to the development of the product. In the preferred embodiment, the development costs are entered as rate-based values, e.g., millions of dollars per year.

Research Region Development Assumptions worksheet 142 may include a “G&A Rate” field 172 that represents “general and administrative” costs. The value in “G&A Rate” field 172 represents a percentage increase of the R&D, clinical, and sales costs entered in each development stage. The total development cost for each development stage, adjusted by the G&A rate, is calculated and displayed in a number of corresponding “Totals” fields 174. Thus, a change in any development cost value or a change in the G&A rate will be reflected in one or more “Totals” fields 174. Alternatively, evaluation system 100 may employ any number of adjustment parameters that enable the user to control the manner in which the development costs are processed.

Evaluation system 100 may display default or suggested development cost values and/or default or suggested development cost profiles when Research Region Development Assumptions worksheet 142 is initialized. For example, as shown in FIG. 3, sales and manufacturing costs are usually not incurred in the early development stages, and R&D costs are usually not incurred in the late development stages. Consequently, evaluation system 100 may insert zeros or very low values in certain fields to reflect such common trends. Indeed, evaluation system 100 may insert an “average” or “typical” development schedule into Research Region Development Assumptions worksheet 142 to serve as a starting point for the user. In accordance with one embodiment of the present invention, the client device obtains development cost assumptions from system server 106, which maintains empirical data related to actual product development programs. In addition, system server 106 may also maintain a database that includes data related to development assumptions, development stage durations and timelines, historical sales data, and/or terms and conditions from real world alliances. System server 106 may update its database 124 to reflect the results of new development programs such that its suggested values accurately portray realistic development costs. Evaluation system 100 may also enable the user to select or otherwise identify any number of product characteristics; evaluation system 100 can analyze these product characteristics and generate suitable default or suggested development cost values, which may be based on empirical test data. For example, evaluation system 100 may store development cost data corresponding to the development of different types of medication (e.g., heart medication, blood pressure medication, antibiotics, etc.), the development of products in specific countries, the type of product (e.g., commercial drug, genetic research products, diagnostic compositions, etc.), the particular companies or entities involved in the development project, or the like. Evaluation system 100 can leverage such data to increase the accuracy of the economic simulation.

FIG. 4 depicts Second Region Development Assumptions worksheet 144, which is displayed when the user selects the “Second Region” entry in selection menu 170 (the following description also applies to the layout and functionality of the Third Region Development Assumptions worksheet). Evaluation system 100 determines the development costs for the second and/or third regions based upon the development costs for the research region. In the example embodiment, the research region development cost values are adjusted according to a number of multipliers entered on the Second Region Development Assumptions worksheet 144. As shown in FIG. 4, Second Region Development Assumptions worksheet 144 may include a number of “Multiplier” fields 176. The example GUI described herein includes an R&D multiplier 178, a Clinical multiplier 180, a Sales multiplier 182, and a Manufacturing multiplier 184. These multipliers correspond to the different cost categories identified on Research Region Development Assumptions worksheet 142.

The total development cost for a given development stage in the second region is calculated by multiplying the respective research region costs (R&D, clinical, sales, and manufacturing) by the corresponding second region multipliers. The adjusted cost values are further multiplied by the G&A rate entered in a “G&A Rate” field 186. As described above, the G&A rate represents a percentage that increases the R&D, clinical, and sales costs for each development stage. Ultimately, the amounts displayed in the “Totals” fields 188 are generated in response to the research region development assumptions values, the values entered in “Multiplier” fields 176, and the value entered in “G&A Rate” field 186. Alternatively, evaluation system 100 may provide full-featured worksheets (similar to Research Region Development Assumptions worksheet 142) for the second and third regions.

Second Region Development Assumptions worksheet 144 also includes a “Time Offset” field 190. The value entered in “Time Offset” field 190 represents the number of years that the development in the second region lags the development in the research region. Evaluation system 100 uses the time offset value when processing the value of the proposed development program.

As described above in connection with the research region, evaluation system 100 may provide default or suggested values for the second region; these values may be derived from actual clinical data or they may be selected according to any number of descriptive parameters entered by the user (e.g., the type of drug).

After Sales Assumptions tab 136 is selected, the user may select a sales curve for use during the evaluation procedure. The example embodiment includes at least two options: a simulated sales curve and a flat sales curve. Of course, any number of alternative or additional sales curves may be utilized by evaluation system 100. As depicted in FIG. 5, Simulated Sales worksheet 146 includes entry fields corresponding to a plurality of different research region sales scenarios (the example embodiment accommodates five scenarios labeled “Blockbuster,” “Above Average,” “Average,” “Below Average,” and “Dog”). The value entered in these fields represents the peak annual sales amount in millions of dollars per year. As described in more detail below, evaluation system 100 processes simulated sales curves by assuming that the amount of annual sales varies over time and eventually reaches a peak value. Consequently, the GUI allows the user to designate what the peak value will be for each scenario. In this respect, the sales assumptions represent a variable sales characteristic with respect to time.

As shown in FIG. 5, each simulated sales scenario has a probability of occurrence associated therewith. In the example embodiment, evaluation system 100 assumes that the “Blockbuster” sales scenario occurs 15% of the time, the “Above Average” sales scenario occurs 20% of the time, the “Average” sales scenario occurs 30% of the time, the “Below Average” sales scenario occurs 25% of the time, and the “Dog” sale scenario occurs 10% of the time. Alternatively, evaluation system 100 may allow the user to adjust these percentages on Simulated Sales worksheet 146.

Simulated Sales worksheet 146 may also include a “2^{nd} Region Multiplier” field 192 and a “3^{rd} Region Multiplier” field 194. Evaluation system 100 uses the values entered in these multiplier fields to calculate the respective sales figures in the second and third regions, based upon the research region sales figures.

As shown in FIG. 6, the user may select Flat Sales worksheet 148 in lieu of Simulated Sales worksheet 146. Flat Sales worksheet 148 assumes that annual sales of the developed product in the research region will remain constant over a given time period. Accordingly, Flat Sales worksheet 148 allows the user to enter a sales amount (in millions of dollars per year), an associated contribution margin percentage, and a time period or lifetime (in years) during which such annual sales are realized. The margin is defined as the excess of a product's sales price over the variable and direct fixed costs associated with manufacturing and marketing. Flat Sales worksheet 148 allows the user to enter sales assumptions representing flat sales characteristics with respect to time (the example embodiment accommodates up to five different flat sales scenarios) and the corresponding odds or likelihood of occurrence for each scenario. Thus, each flat sales scenario is defined by an “Odds” field 196, a “Sales” field 198, a “Lifetime” field 200, and a “Margin” field 202. Alternatively, evaluation system 100 may be suitably configured to support flat sales curves having any number of variable parameters or characteristics.

Evaluation system 100 randomly chooses one of the flat sales curves based on the designated odds of occurrence. In this respect, the sum of the values in the “Odds” fields 196 should equal 100%.

As described above in connection with Simulated Sales worksheet 146, Flat Sales worksheet 148 may also include a “2^{nd} Region Multiplier” field 204 and a “3^{rd} Region Multiplier” field 206. The corresponding multiplier values are used to calculate the sales figures in the second and third regions, based upon the flat sales figures for the research region.

As described above in connection with the development assumptions, evaluation system 100 may display default or suggested sales assumptions when a sales worksheet is initialized. The initial sales figures and other sales parameters may be generated in response to empirical data related to actual product sales trends. In this regard, database 124 can include actual or estimated sales data for similar products such that the initial sales figures accurately portray realistic income from sales of the developed product. In addition, evaluation system 100 may also enable the user to select or otherwise identify any number of product characteristics, e.g., the type of drug. Evaluation system 100 can analyze these product characteristics and generate suitable default or suggested sales parameters, which may be based on empirical test data.

Guaranteed Payments worksheet 150 preferably includes at least one payment schedule (FIG. 7 depicts two independent schedules on worksheet 150). As used herein, a guaranteed payment is an amount that is paid as a lump-sum (or distributed over time) at a particular time. In this regard, Guaranteed Payments worksheet 150 includes a number of “Payment” fields 208 and a corresponding number of “Time of Receipt” fields 210. Payment values are entered in millions of dollars and time values are entered in number of years. In the example embodiment, the time values are relative to the commencement of a designated development stage. Accordingly, Guaranteed Payments worksheet 150 includes a selection menu 212 that allows the user to designate a triggering event for purposes of the guaranteed payments schedule. Selection menu 212 may include any number of entries corresponding to the various development stages and/or other triggering events that determine, at least in part, when guaranteed payments are made. For example, selection menu 212 may include the following entries: “Discovery,” “Validation,” “Preclinical,” “IND Filed,” “Phase I,” “Phase II,” “Phase III,” “NDA filed,” Commercial Sales,” and “Current Stage.” The “Current Stage” entry corresponds to the current development stage indicated on Run worksheet 164 (described below). Alternatively, Guaranteed Payments worksheet 150 may allow the user to enter specific dates corresponding to the triggering of one or more payments.

Sponsored Research worksheet 152 may be used to define a schedule of sponsored payments or employee resources. In the example model, sponsored research may be expressed in terms of an annual rate (millions of dollars per year) or in terms of a number of full time equivalent employees (FTE). If FTEs are used, then a monetary value for each employee is entered in an “FTE Rate” field 214. Although not shown in FIG. 8, Sponsored Research worksheet 152 may also accommodate other forms of sponsored research.

Sponsored Research worksheet 152 allows the user to specify a plurality of time periods having separate sponsorship terms. The example worksheet 152 accommodates up to five different sponsored research components. Each sponsored research component includes a “Starting Time” field 216, an “Ending Time” field 218, and a “Rate” field 220. The starting time represents (in number of years) when the sponsored research begins and the ending time represents (in number of years) when the sponsored research ends (in lieu of relative time values, Sponsored Research worksheet 152 may allow the user to designate specific starting and ending dates corresponding to each sponsored research component). In this manner, the sponsored research schedule identifies at lest one time period during which the sponsored research benefits are given to the R&D entity. The rate represents either a dollar amount (in millions of dollars per year) or a number of FTEs. In the example embodiment, the starting and ending times are relative to the commencement of a designated development stage. Accordingly, Sponsored Research worksheet 152 includes a selection menu 222 having the same function and features of selection menu 212 (described above in connection with FIG. 7).

Milestone payments are paid upon the occurrence of a given event, e.g., the completion or initiation of a product development stage. In this regard, Milestone Payment worksheet 154 preferably includes a number of data entry fields corresponding to a number of development stages or triggering events recognized by evaluation system 100. Milestone Payment worksheet 154 preferably includes, without limitation, the following milestones: “Target Validation,” “Preclinical Initiation,” “Clean Toxicology,” “IND Filed,” “Phase II Initiation,” “Phase III Initiation,” “NDA/PLA Filed,” and “Approval.” The user can enter the milestone payments (if any) corresponding to each of these milestones.

Although not depicted in FIG. 9, Milestone Payment worksheet 154 may accommodate other milestones, which may or may not be related to the development of the product. In addition, Milestone Payment worksheet 154 may be configured to allow the user to define any number of milestone events.

Milestone Payments worksheet 154 preferably includes separate milestone payment schedules corresponding to each of the different regions. For example, Milestone Payments worksheet 154 may include a research region schedule 224, a second region schedule 226, and a third region schedule 228.

Expense Reimbursement worksheet 156 can be used when one entity agrees to underwrite a portion of the R&D company's expenses. Thus, as shown in FIG. 10, Expense Reimbursement worksheet 156 preferably includes data entry fields corresponding to each product development stage. In the example embodiment, the values entered in these data entry fields represent reimbursement percentages.

Expense Reimbursement worksheet 156 preferably includes separate reimbursement schedules corresponding to each of the different regions; each schedule preferably identifies a plurality of product development stages and a corresponding plurality of expense reimbursement percentages. For example, Expense Reimbursement worksheet 156 may include a research region schedule 230, a second region schedule 232, and a third region schedule 234. As an example, the worksheet shown in FIG. 10 represents an arrangement whereby the partnered entity pays 75% of the clinical expenses incurred by the R&D entity in all three regions.

Although not shown in FIG. 10, Expense Reimbursement worksheet 156 may allow the user to enter minimum and/or maximum dollar amounts corresponding to any number of individual expense reimbursements.

Royalty Payments worksheet 158 includes separate royalty schedules corresponding to each of the different regions. In this regard, Royalty Payments worksheet 158 includes a research region schedule 236, a second region schedule 238, and a third region schedule 240. Of course, Royalty Payments worksheet 158 may accommodate additional regional royalty schedules as needed. The following description applies to all three royalty schedules.

Each royalty schedule allows the user to select one of three options: “No Threshold,” “Cumulative Threshold,” and “Annual Threshold.” Alternatively, Royalty Payments worksheet 158 may be configured to support any number of different royalty payment scenarios, e.g., royalty payments based on volume of units sold, time-based royalty payment schedules, multiple party royalty arrangements, or the like. The three options described herein reflect royalty payment arrangements that are common to the biotechnology and pharmaceutical industry.

As shown in connection with research region schedule 236, the “No Threshold” option represents a simple royalty arrangement based on a single royalty rate. In this example, the R&D company earns a 7% royalty regardless of the sales figures. In contrast, the “Annual Threshold” option is selected for the second region schedule 238. This model allows the user to vary the royalty rate when annual sales reach specified thresholds. Accordingly, the associated royalty payment schedule preferably identifies a number of threshold royalty amounts corresponding to a like number of royalty rates. In this example, the R&D company earns a 7% royalty until annual sales reach $300 million. Thereafter, the R&D company earns a 10% royalty regardless of the annual sales figures. The “Cumulative Threshold” option, which has been selected for the third region schedule 240, allows the user to vary the royalty rate when cumulative sales reach specified thresholds. In this example, the R&D company earns a 6% royalty until the cumulative sales reach $800 million. Thereafter, the R&D company earns an 8% royalty until the cumulative sales reach $1600 million. Finally, for sales in excess of $1600 million, the R&D company earns a 10% royalty.

Referring to FIG. 12, Profit Split worksheet 160 includes separate profit split schedules corresponding to each of the different regions. In this regard, Profit Split worksheet 160 includes a research region schedule 242, a second region schedule 244, and a third region schedule 246. Of course, Profit Split worksheet 160 may accommodate additional regional schedules as needed. The following description applies to all three profit split schedules.

A given profit split schedule allows the user to define a profit splitting arrangement between the R&D company and the partnered company. Although evaluation system 100 can be suitably configured to support any number of profit splitting arrangements, Profit Split worksheet 160 assumes that profit splitting will be defined as a percentage of profits given to the R&D company (i.e., the R&D company's “take”) during a specified time period. Each profit split schedule accommodates up to five splits, thus enabling the user to define different take percentages for different time periods. In this regard, Profit Split worksheet 160 includes a number of “Start” fields 248, a number of “Finish” fields 250, a number of “Take” fields, e.g., at least a first “Take” field 252 and a second “Take” field 254, and a “# Splits” selection menu 256.

In the simplest case of only one profit split, the user will select the “One” entry in “# Splits” selection menu 256. Thereafter, the user need only enter a value in first “Take” field 252; this value represents the percentage of profits given to the R&D company, regardless of time. In contrast, FIG. 12 depicts an example situation having two profit splits. For this situation, the user will select the “Two” entry in “# Splits” selection menu 256. This selection causes evaluation system 100 to activate first “Take” field 252, second “Take” field 254, the “Start” field 248 corresponding to “Take” field 252, and the “Finish” field 250 corresponding to “Take” field 252. The first profit split of 50% (entered in first “Take” field 252) applies from year 0.00 (entered in the corresponding “Start” field 248) until year 5.00 (entered in the corresponding “Finish” field 250). In the preferred example embodiment, the “Start” and “Finish” values represent the number of years relative to the beginning of commercial sales. Alternatively, Profit Split worksheet 160 may allow the user to designate specific start and finish dates, identify a reference date or milestone, or provide any suitable time schedule. The second profit split of 70% (entered in second “Take” field 254) applies after year 5.00. In this manner, the user can enter the take percentages for up to five different time periods by identifying at least two profit splitting percentages and at least one time period during which one of the two percentages is effective.

Referring to FIG. 13, Supply Agreement worksheet 162 can be used when the R&D company manufactures the product and supplies it to the partnered company, which is responsible for selling the product. Supply Agreement worksheet 162 preferably includes separate supply agreement schedules corresponding to each of the different regions. In this regard, Supply Agreement worksheet 162 includes a research region schedule 258, a second region schedule 260, and a third region schedule 262. Of course, Supply Agreement worksheet 162 may accommodate additional regional royalty schedules as needed. The following description applies to all three supply agreement schedules.

Supply Agreement worksheet 162 allows the user to select whether the terms are based on net sales or based on the cost of goods sold (CoGS). Regardless of which option is selected, the user enters a percentage value that represents an amount paid or returned to the R&D company. For example, as depicted in connection with research region schedule 258, if the net sales option is selected, then the percentage value (e.g., 30%) represents the percentage of net sales returned to the R&D company. On the other hand, as depicted in connection with second region schedule 260, if the CoGS option is selected, then the percentage value (e.g., 150%) represents the percentage of manufacturing costs returned to the R&D company.

Although not shown in FIG. 13, Supply Agreement worksheet 162 may include date fields or milestone fields that enable the user to define different percentage rates for any number of time periods.

Referring to FIG. 14, Run worksheet 164 includes a number of data fields that affect the processing performed by evaluation system 100. For example, Run worksheet 164 may include a likelihood of success schedule 264 having a number of data entry fields corresponding to each of the different product development stages. The values contained in these data entry fields represent the odds that a given stage will be successfully completed. In the example shown in FIG. 14, the discovery stage will be successfully completed 100% of the time. However, the validation stage will only be completed 75% of the time. Evaluation system 100 uses these probabilities to randomly determine whether the proposed development program is ultimately successful in any given simulation iteration and, if not, the last successfully completed stage in that iteration.

Run worksheet 164 may also include a “Rate” field 266. The value entered in “Rate” field 266 represents a rate of return that an entity could earn via an equivalent investment. Evaluation system 100 utilizes this rate to calculate the net present value of the proposed development program.

An “Iterations” field 268 contains the number of random iterations to be performed by evaluation system 100. As described in more detail herein, evaluation system randomly determines the value of the proposed development program using a number of probabilistic functions; a value is determined for each processing iteration. “Iterations” field 268 allows the user to enter the number of iterations performed by evaluation system 100. Evaluation system 100 may provide a default iteration value, e.g., 10,000, to ensure that enough data points are collected to support a meaningful statistical distribution.

Run worksheet 164 may include a “Current Development Stage” selection menu 270, which preferably includes selectable entries corresponding to each of the different product development stages. The selected entry identifies the development stage that has already been reached in the research region. Thus, in the example shown in FIG. 14, the development has already progressed to the preclinical stage at the time evaluation system 100 executes. As described above, the selected entry may also impact calculations associated with Guaranteed Payments worksheet 150 and/or Sponsored Research worksheet 152.

Once all of the necessary data is entered in the various worksheets, the user may select a “Run” button 272 to begin the simulation. Eventually, the results of the simulation are displayed in a results window 274. In addition, graphs, reports, charts, and/or other graphical representations of the results can be accessed via a “Graph” button 276.

As described above in connection with the development assumptions and the sales assumptions, evaluation system 100 may display default or suggested values for the probabilities of success, the rate of return, and/or the number of iterations when Run worksheet 164 is initialized. These and possibly other parameters may be generated in response to empirical data related to economic trends, actual product development programs, or the like. In this regard, database 124 can include actual or estimated data corresponding to historical success probabilities for similar products such that the initial success probabilities accurately portray realistic product development stages. In addition, evaluation system 100 may also enable the user to select or otherwise identify any number of product characteristics; evaluation system 100 can analyze these product characteristics and generate suitable default or suggested success probabilities, which may be based on empirical test data.

Evaluation Techniques

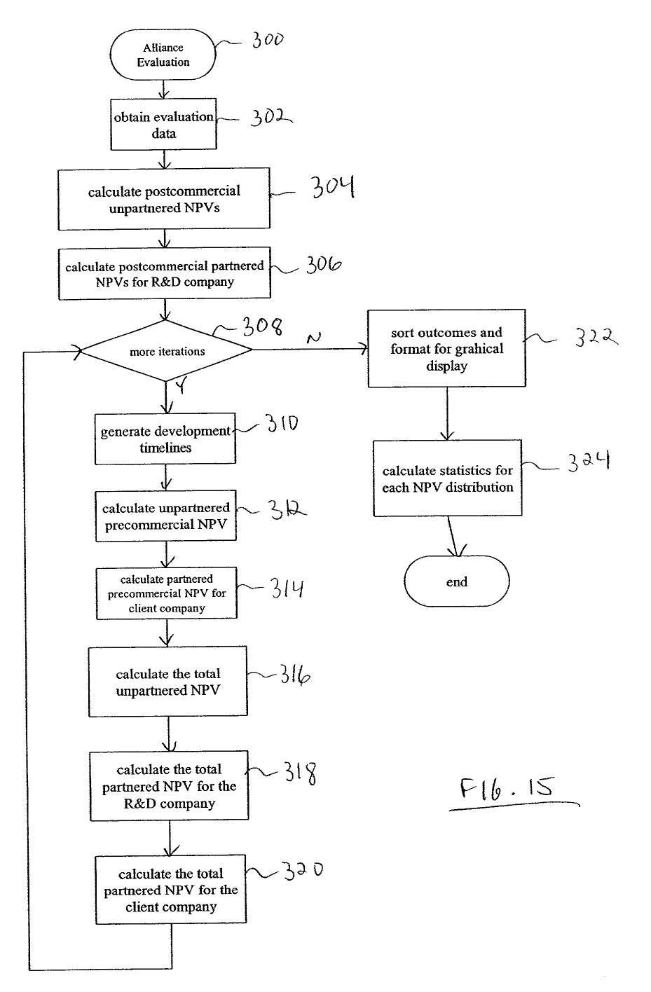

FIG. 15 is a flow diagram of an example alliance evaluation process 300 that may be performed by evaluation system 100. Initially, evaluation system 100 obtains evaluation data (task 302) related to terms, conditions, parameters, variables, quantities, amounts, probabilities, and/or other characteristics of the proposed development program. For example, task 302 may obtain any of the following evaluation data types (without limitation): a set of development cost assumptions corresponding to any number of product development stages; a set of sales assumptions representing sales of a developed product; alliance structure components related to a proposed alliance between a first entity and at least one other entity; guaranteed payment terms representing guaranteed payments from one entity to another; sponsored research terms representing sponsored research benefits given to an entity; milestone payment terms representing milestone payments from one entity to another; expense reimbursement terms representing expense reimbursements given to an entity; royalty payment terms representing royalty payments to an entity; profit splitting terms representing profit splits between two entities; supply agreement terms between two entities; quantities representing the likelihood of completing any given development stage; and any other data described herein. Any given evaluation data element may be provided by the user (e.g., obtained by the client device or computer system) or provided by evaluation system 100 (e.g., obtained from a server computer system that communicates with the client system via a communication link, or obtained as a default value). As described above, any given evaluation data point or any given set of evaluation data points may be created in response to empirical product development, sales, marketing, performance, and/or research data.

By obtaining the evaluation data, evaluation system 100 is capable of defining an unpartnered development program or an alliance structure between a first entity (e.g., an R&D company) and at least one other entity (e.g., a commercial pharmaceutical company). As described above, evaluation system 100 accommodates various alliance structure components corresponding to different development regions. For example, the development assumptions and the sales assumptions may include different components corresponding to different regions. In accordance with most common alliances, evaluation system 100 may assume that the first entity is responsible for the development of the product and that the other entity (or entities) provide economic support to the first entity during the proposed development program. In this regard, the alliance structure can also be suitably defined such that the other entity (or entities) obtains an economic benefit derived from sales of the product.

Once the evaluation data is obtained, alliance evaluation process 300 may calculate postcommercial unpartnered NPVs associated with any of the possible predefined sales scenarios (task 304). Referring to FIGS. 5 and 6, the illustrated example of evaluation system 100 accommodates a limited number of possible sales scenarios based upon the initial sales assumptions: up to five possible simulated sales curves and up to five possible flat sales curves. In the practical embodiment, the user will select either flat or simulated sales curves, thus reducing the computational load to only five individual sales scenarios. Consequently, the precalculation of all possible postcommercial unpartnered NPVs is relatively easy and efficient. Alternatively, evaluation system 100 can calculate each postcommercial unpartnered NPV in each iteration loop (described in more detail below) after the specific sales scenario has been determined.

Evaluation system 100 calculates the postcommercial unpartnered NPVs using the formulas and relationships described below. During task 304, evaluation system 100 calculates the postcommercial unpartnered NPVs relative to the beginning of commercial sales of the product, i.e., the NPV calculations assume that the current time is the time of first commercial sales. These NPV values can be time-adjusted if necessary to account for the actual date of first commercial sales. NPVs (for the research region) based on the simulated sales curves are generated in response to the peak annual sales value, the characteristics of the particular simulated sales curve, the contribution margin, and the equivalent rate of return (designated on Run worksheet 164). The evaluation system 100 uses multipliers to determine the second and/or third region postcommercial unpartnered NPV. In addition, the NPVs for the second and third regions are adjusted to accommodate for any applicable development time offsets. The contributions from all of the regions are added to obtain the total postcommercial unpartnered NPV for each possible sales scenario; evaluation system 100 saves these total NPV values for later use.

Continuing, evaluation system 100 also calculates the postcommercial partnered NPVs (if applicable) for the R&D entity (task 306). As described above, these postcommercial partnered NPVs are calculated relative to the time of first commercial sales. For partnered alliances, the various postcommercial alliance structure components are analyzed to account for income (and/or expenses) realized by the R&D entity. For example, evaluation system 100 will process any royalty payments, profit splitting income, and supply agreement payments defined in the respective worksheets. The manner in which evaluation system 100 handles these particular alliance structure components is described in detail below.

It may be necessary for evaluation system 100 to individually determine the postcommercial partnered NPVs corresponding to the second and third regions to the extent the alliance structure defines different payment terms in those regions. The NPVs for the second and third regions are adjusted to account for any development time offsets. Eventually, the contributions from all of the regions are added to obtain the total postcommercial partnered NPV for the R&D entity; these total NPV values are saved for later use. These calculations effectively evaluate potential sales of the proposed product, using the various sales assumptions contained on the worksheets.

At this point, alliance evaluation process 300 iteratively calculates a distribution of NPVs that characterizes the proposed product development program. As described above in connection with Run worksheet 164, the user can designate the number of iterations performed during process 300. If more iterations remain unprocessed (query task 308), then process 300 generates product development timelines for the research region and for any other region (task 310). In the preferred practical embodiment, a “development timeline” may identify each of the successfully completed product development stages, the duration of each successfully completed product development stage, the overall duration of the proposed development program (whether or not it is ultimately successful), and the relative dates (in number of years) corresponding to the beginning and ending of each successfully completed product development stage. Notably, the number of years can be expressed as any real number to reflect portions of any given year.

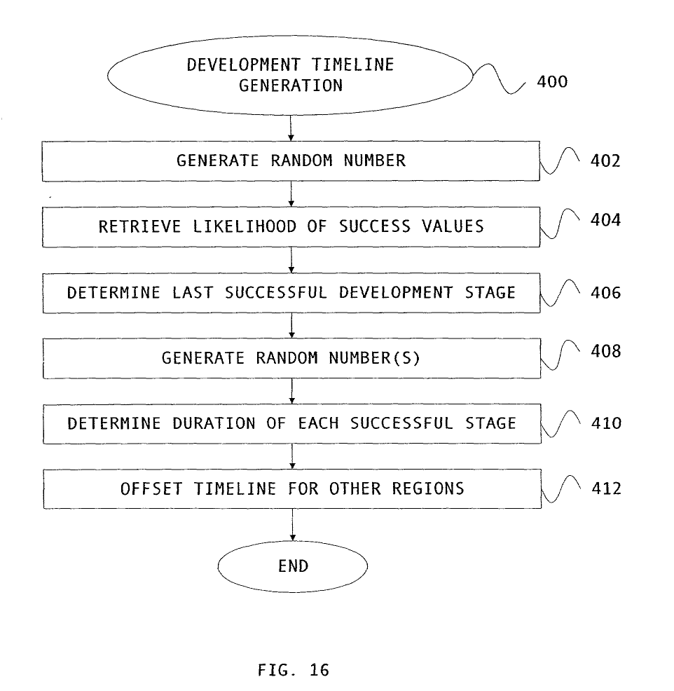

Referring now to FIG. 16, evaluation system 100 may perform a development timeline generation process 400 during task 310. The preferred embodiment initially generates a development timeline for the research region, and uses that timeline to derive the development timelines for the other regions. Process 400 may begin by generating a random number (task 402) using any suitable technique. Continuing, evaluation system 100 retrieves the likelihood of success values (task 404) contained in likelihood of success schedule 264 (see FIG. 14). The random number and the success odds (or percentages) are processed by a suitable algorithm to determine the last successful development stage reached during the current iteration (task 406). In this respect, evaluation system 100 employs a probabilistic function to randomly determine whether any product development stage was successful and, if so, which stages were successfully completed. Although this determination is random in some respects, the ultimate outcome will be dictated by the likelihood of success values entered in schedule 264. For example, if all of the success values are 100%, then the simulated product development program will be fully completed in each iteration. On the other hand, if the success value for the first stage is 0%, then the simulated product development program will never progress to the second stage. Even if process 400 determines that the proposed development program fails in the current iteration, evaluation system 100 will still calculate a corresponding NPV for the iteration (the NPV will be a negative value that reflects the development expenses incurred by the R&D entity).

Continuing, evaluation system 100 may generate one or more additional random numbers (task 408) and process the random number(s) to determine the time duration of each successful product development stage (task 410). In the preferred embodiment, evaluation system 100 generates one new random number per stage. Alternatively, evaluation system 100 may utilize a single random number and a suitable algorithm or formula to determine the duration of a plurality of stages. Thus, evaluation system 100 may utilize one or more probabilistic functions to determine the individual duration for each successful stage. In accordance with one practical embodiment, the duration of each development stage is governed by a simple table or matrix of possible outcomes. For example, evaluation system 100 may assume that the duration of the initial discovery stage is always one year, while the duration Phase II stage will either be one year, two years, or three years, based on predetermined probabilities. Alternatively, evaluation system 100 may calculate the individual stage durations based on actual clinical data, historical simulation data, or any suitable relationship or algorithm.

The development timelines for the second and third regions (if applicable) can be generated by offsetting the research region timeline according to the time offset values entered on the second and third region development assumptions worksheets (see FIG. 4). The example embodiment of evaluation system 100 assumes that the duration of any given development stage is the same for every region. In addition, the example version of evaluation system 100 assumes that termination of the development program in the research region leads to immediate termination of the program in all other regions. Alternately, evaluation system 100 can generate the second and third region development timelines in an independent manner.

Next, evaluation system 100 calculates the unpartnered precommercial NPV for the current iteration (task 312) based on the development assumptions for the various regions. Briefly, the cash bum rates set forth in the development assumptions are used to develop a cash flow timeline for each region. The cash flow timelines are based on the totals for each development stage as shown on the respective development assumptions worksheets (see FIGS. 3 and 4). As described above, the totals for the research region are affected by the designated G&A rate, and the totals for the second and third regions are based on the totals for the research region, the G&A rate, and the multipliers related to the specific cost categories.

During task 312, an NPV is calculated for each cash flow timeline. The NPVs for the second and third regions are reduced exponentially by the time offset values for the respective region (the NPV calculation and time-shifting of NPVs are described below). Evaluation system 100 adds the unpartnered precommercial NPVs together to obtain the total unpartnered precommercial NPV for the current iteration. In the example embodiment, this total value is a negative number, which represents non-reimbursed expenses incurred by the R&D entity. This total value is saved for later use.

Alliance evaluation process 400 continues by calculating the partnered precommercial NPV for the second entity, e.g., the client company, the partnering company, the sponsoring company, or any entity other than the R&D entity (task 314). During task 314, evaluation system 100 retrieves all applicable precommercial deal structure components and the corresponding data points. In the practical embodiment, the development timelines for each region (see task 310) are compared to the data entries in the various precommercial deal structure worksheets to develop cash flow timelines of payments from the second entity to the R&D entity. The development timelines provide triggering events and time durations that may impact whether payments are made and, if so, when such payments occur. The handling of the various precommercial deal structure components is described in more detail below.

Evaluation system 100 calculates a partnered precommercial NPV for each of the development regions. As described previously, the NPV values for the second and third regions may be exponentially adjusted to reflect any designated development time offsets. The evaluation system 100 adds the regional NPV values to obtain a total partnered precommercial NPV for the current iteration. In the example embodiment, this total is a negative number because it represents the partnered precommercial NPV for the second entity, which experiences negative cash flow during the product development. Equivalently, this total value may be expressed as a positive value that represents an offset to the partnered precommercial NPV for the R&D company.

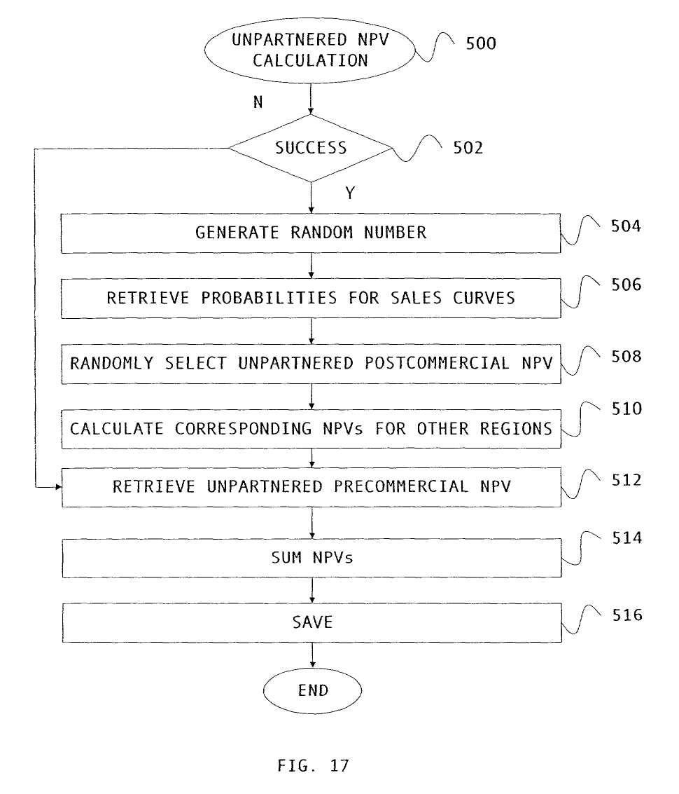

Continuing, alliance evaluation process 400 calculates the total unpartnered NPV for the current iteration (task 316). The preferred practical embodiment calculates the total unpartnered NPV in accordance with the process 500 shown in FIG. 17. If the current iteration has determined that the final product development stage has been successfully completed (query task 502), then process 500 proceeds to a task 504. If evaluation system 100 determines that the proposed development program is not successful, then process 500 proceeds to a task 512.

During task 504, evaluation system 100 generates a random number using any suitable technique. In addition, evaluation system 100 may retrieve the probabilities for the various sales curves or scenarios (task 506) as set forth on the applicable sales assumptions worksheet (see FIGS. 5 and 6). The random number is used to randomly determine which of the designated sales curves applies to the current iteration. Thus, evaluation system 100 utilizes a probabilistic function to determine, at least in part, a simulated sales scenario based upon the sales assumptions. In the example embodiment described herein, the corresponding unpartnered postcommercial NPVs are precalculated in task 304. Consequently, process 500 randomly selects one of the unpartnered postcommercial NPVs (task 508) based on the random number and the probabilities.

The unpartnered postcommercial NPVs for the second and third regions are calculated using any applicable sales multipliers (see the sales assumptions worksheets) and any applicable development time offsets (time offsets may impact postcommercial payments). Thus, following task 510, evaluation system 100 has obtained the unpartnered postcommercial NPVs for each of the development regions. Of course, no unpartnered postcommercial NPV component will be considered if the product development was unsuccessful in the current iteration. Whether or not the product was successfully developed, evaluation system 100 retrieves the unpartnered precommercial NPV (task 512) calculated in task 312.

Continuing, evaluation system 100 sums the unpartnered postcommercial NPVs for all of the regions and the unpartnered precommercial NPV (task 514) to obtain a grand total representing the unpartnered NPV for the current iteration. This grand total is saved for later use (task 516).

Referring again to FIG. 15, evaluation system 100 calculates the total partnered NPV for the R&D company (task 318) in a similar manner. As described in connection with process 500, evaluation system 100 randomly selects one of the precalculated postcommercial partnered NPVs (see task 306) for use with the current iteration. The corresponding partnered postcommercial NPVs for second and third regions are calculated based on the research region value, any sales multipliers, and any time offsets. The partnered postcommercial NPVs for the different regions are added to obtain the total partnered postcommercial NPV. Ultimately, the total partnered NPV for the R&D company is determined in accordance with the following relationship:

Total Partnered NPV for R&D Entity=(total unpartnered precommercial NPV; from task 316)−(total partnered precommercial NPV for the second entity; from task 314)+(total partnered postcommercial NPV).

Note that the value for the total partnered precommercial NPV for the second entity will be a negative number. The total partnered NPV for the R&D company is saved for later use.

Continuing, alliance evaluation process 300 calculates the total partnered NPV for the second entity (task 320) according to the following relationship:

Total Partnered NPV for Second Entity=(total partnered precommercial NPV for second entity; from task 314)+(total unpartnered postcommercial NPV; from task 304)−(total partnered postcommercial NPV for the R&D entity; from task 318).

In practice, evaluation system 100 expresses the various NPV values contained in the above two relationships as real numbers. Consequently, the ultimate calculation is reduced to a simple arithmetic operation on real numbers.

Eventually, alliance evaluation process 300 calculates three NPVs for each iteration: the unpartnered NPV, the NPV for the R&D entity, and the NPV for the second entity. Generally, evaluation system 100 calculates at least one NPV for the proposed development program in response to a development cost assumptions, sales assumptions, and/or simulated development and cash flow timelines. For a given entity, evaluation system 100 can process projected costs and income associated with the development and/or sales of a product.

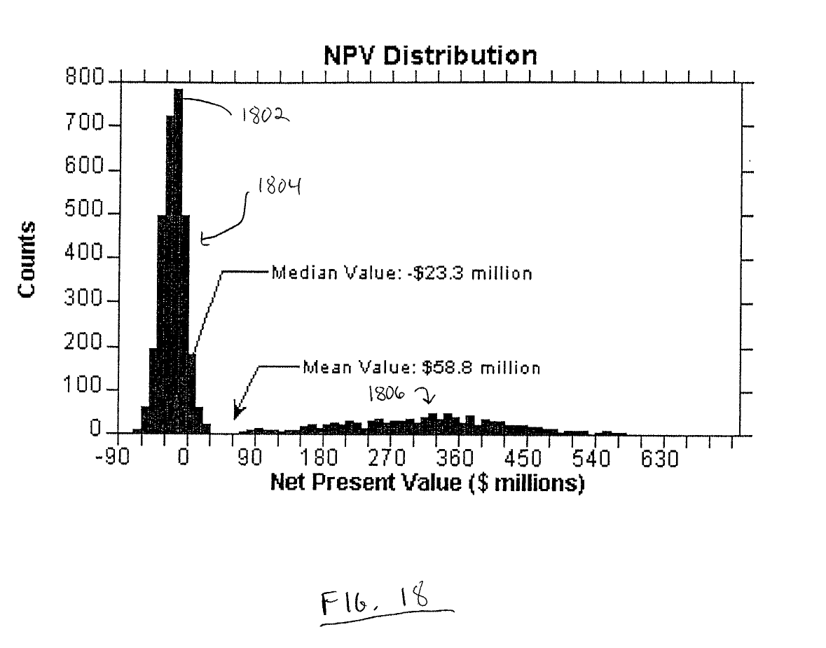

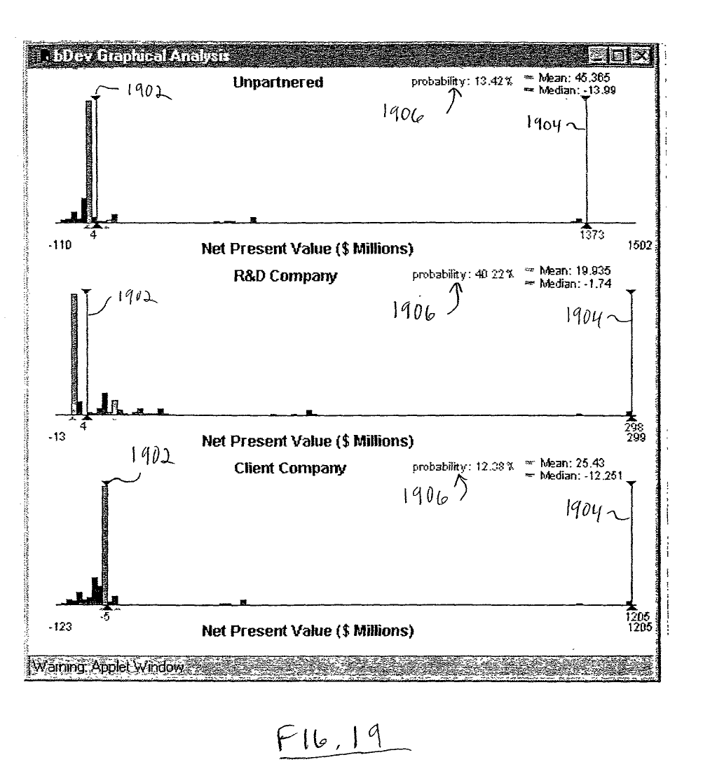

After the designated number of iterations are completed, evaluation system 100 may sort the results and outcomes and format the data for graphical display (task 322). In addition, evaluation system 100 may calculate statistics for each NPV distribution (task 324). For example, evaluation system 100 preferably generates a statistical representation of the NPVs for the simulation, e.g., a mean NPV and/or a median NPV (see FIG. 14). FIGS. 18 and 19 depict example NPV distribution graphs corresponding to a simulation run. Evaluation system 100 performs an economic analysis of the NPVs and generates one or more of these output formats, each of which is indicative of an economic value of the proposed development program. The user can quickly review these results and compare results for different alliance structures to determine which alliance would make more economic sense.

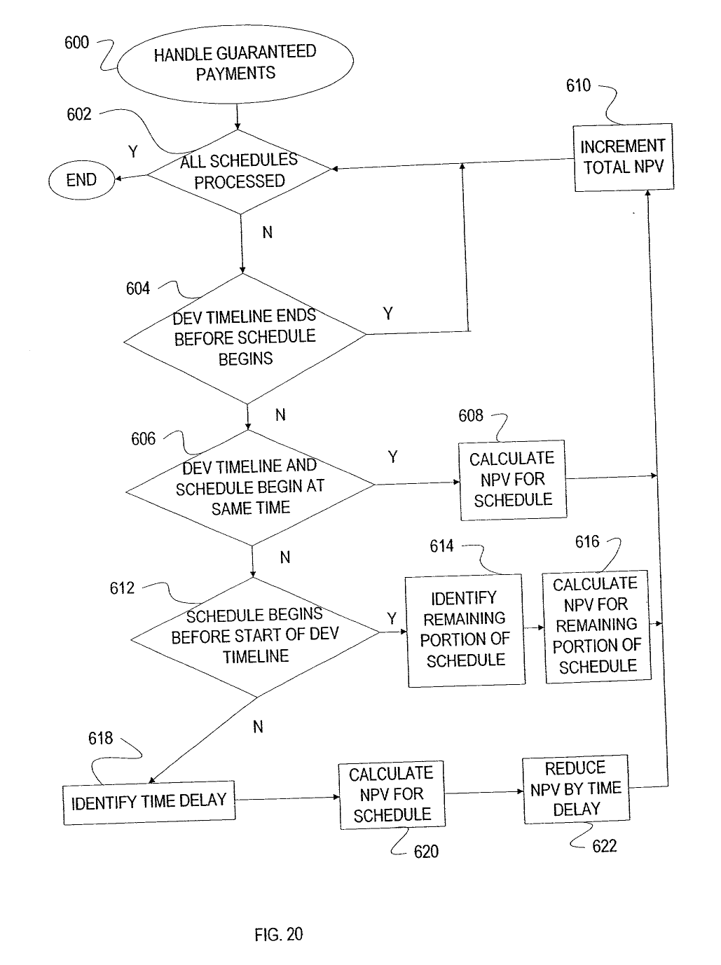

FIG. 20 is a flow diagram of a process 600 for handling guaranteed payments. As described above in connection with FIG. 7, evaluation system 100 may provide one or more guaranteed payment schedules corresponding to guaranteed payment terms. Process 600 may be performed by evaluation system 100 during alliance evaluation process 300 (see FIG. 15). For example, process 600 may be employed during the calculation of the partnered precommercial NPV for the second entity (see task 314). In this regard, process 600 may be performed in an iterative manner.

Briefly, evaluation system 100 calculates a guaranteed payment NPV for each guaranteed payment schedule and sums the NPVs to obtain a total guaranteed payment NPV. The guaranteed payment schedules are defined in the guaranteed payment worksheet, and the schedules represent the payment amounts and corresponding payment times (which may be relative to a specified development stage or the current development stage). Thus, process 600 may include a query task 602 that determines whether all of the guaranteed payment schedules have been processed. If so, then process 600 ends. If not, then evaluation system 100 determines whether the research region development timeline for the current iteration ends before the guaranteed payment schedule begins (query task 604). If so, then evaluation system 100 assumes that the guaranteed payments for the current schedule do not contribute to the total guaranteed payment NPV, and process 600 is reentered at query task 602.

Continuing, evaluation system 100 determines whether the research region development timeline for the current iteration begins at the same time as the current guaranteed payment schedule (query task 606). If so, then evaluation system 100 calculates the NPV corresponding to the entire guaranteed payment schedule (task 608). In the preferred practical embodiment, evaluation system 100 calculates guaranteed payment NPVs using a lump-sum NPV formula (described below). Thereafter, evaluation system 100 increments the total guaranteed payment NPV by this newly calculated result (task 610), and reenters process 600 at query task 602.

If the guaranteed payment schedule begins before the start of the research region development timeline for the current iteration (query task 612), then evaluation system 100 identifies or determines the remaining portion of the guaranteed payment schedule (task 614). Equivalently, evaluation system 100 may remove or truncate that portion of the guaranteed payment schedule that occurs before the start of the research region development timeline. Thereafter, evaluation system 100 calculates the NPV corresponding to the remaining portion of the guaranteed payment schedule (task 616), and increments the total guaranteed payment NPV (task 610).

The negative output of query task 612 represents the scenario where the guaranteed payment schedule begins after the start of the research region development timeline. In this situation, evaluation system 100 identifies or determines the time delay between the start of the research region development timeline and the start of the current guaranteed payment schedule (task 618). Next, evaluation system 100 calculates the guaranteed payment NPV for the entire guaranteed payment schedule (task 620) and reduces the calculated NPV (task 622) according to the identified time delay (see task 618). Thereafter, evaluation system 100 increments the total guaranteed payment NPV (task 610).

The NPV calculations in process 600 are repeated for each of the guaranteed payment schedules, and the final total NPV for the guaranteed payment schedules contributes to the overall NPV determinations described above in connection with FIG. 15.

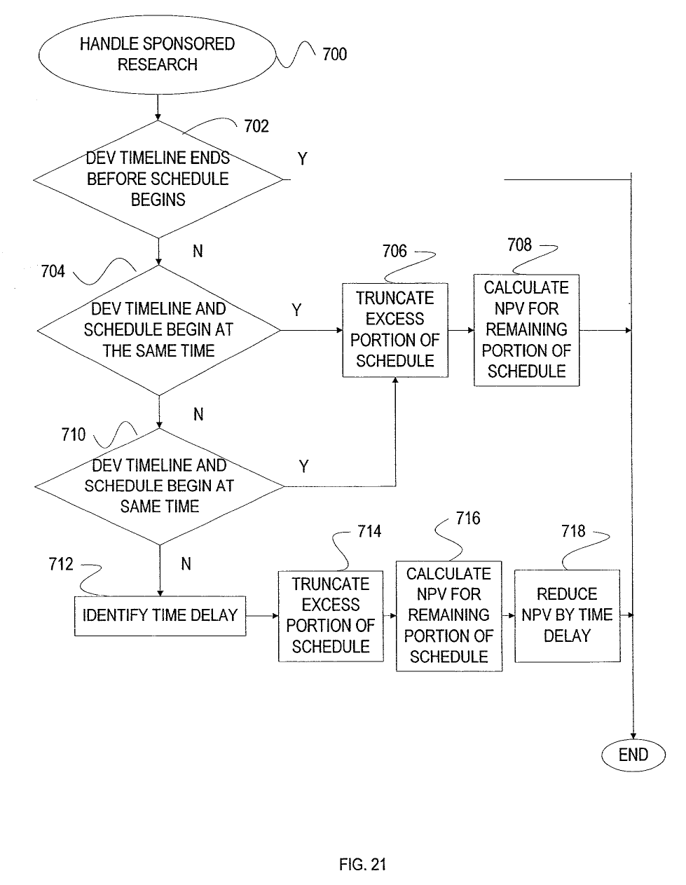

FIG. 21 is a flow diagram of a process 700 for handling sponsored research terms. As described above in connection with FIG. 8, evaluation system 100 may provide one or more sponsored research schedules corresponding to sponsored research terms. As described above, the sponsored research schedule is defined in the sponsored research worksheet, and the schedule represents payments (or number of FTEs) and corresponding time periods (which may be relative to a specified development stage or the current development stage). Process 700 may be performed by evaluation system 100 during alliance evaluation process 300 (see FIG. 15). For example, process 700 may be employed during the calculation of the partnered precommercial NPV for the second entity (see task 314). In this regard, process 700 may be performed in an iterative manner.

Initially, if the research region development timeline ends before the sponsored research schedule begins (query task 702), then evaluation system 100 assumes that the sponsored research terms do not contribute to the NPV calculation and process 700 ends. However, if the research region development timeline and the sponsored research schedule begin at the same time (query task 704), then evaluation system 100 removes or truncates the excess portion of the sponsored research schedule (task 706). In this scenario, task 706 will remove any portion of the sponsored research schedule that continues beyond the end of the research region development timeline. Thereafter, evaluation system 100 calculates the sponsored research NPV for the remaining portion of the sponsored research schedule (task 708). In the preferred practical embodiment, evaluation system 100 utilizes a rate-based NPV formula (described below) to calculate sponsored research NPVs.

If the sponsored research schedule begins before the start of the research region development timeline (query task 710), then task 706 functions to truncate or remove the portion of the sponsored research schedule that occurs before the start of the research region development timeline and the portion of the sponsored research schedule that continues beyond the end of the research region development timeline. The remaining portion of the sponsored research schedule serves as the basis for the corresponding NPV calculation in task 708.

The negative output of query task 710 represents the scenario where the sponsored research schedule begins after the start of the research region development timeline. In this situation, evaluation system 100 identifies or determines the time delay between the start of the research region development timeline and the start of the sponsored research schedule (task 712). In addition, evaluation system 100 truncates or removes any excess portion of the sponsored research schedule that continues beyond the end of the research region development timeline (task 714). Thereafter, evaluation system 100 calculates the sponsored research NPV corresponding to the remaining portion of the sponsored research schedule (task 716) and reduces the resulting NPV (task 718) according to the time delay identified in task 712.

Ultimately, the sponsored research NPV for the sponsored research schedule contributes to the overall NPV determinations described above in connection with FIG. 15.

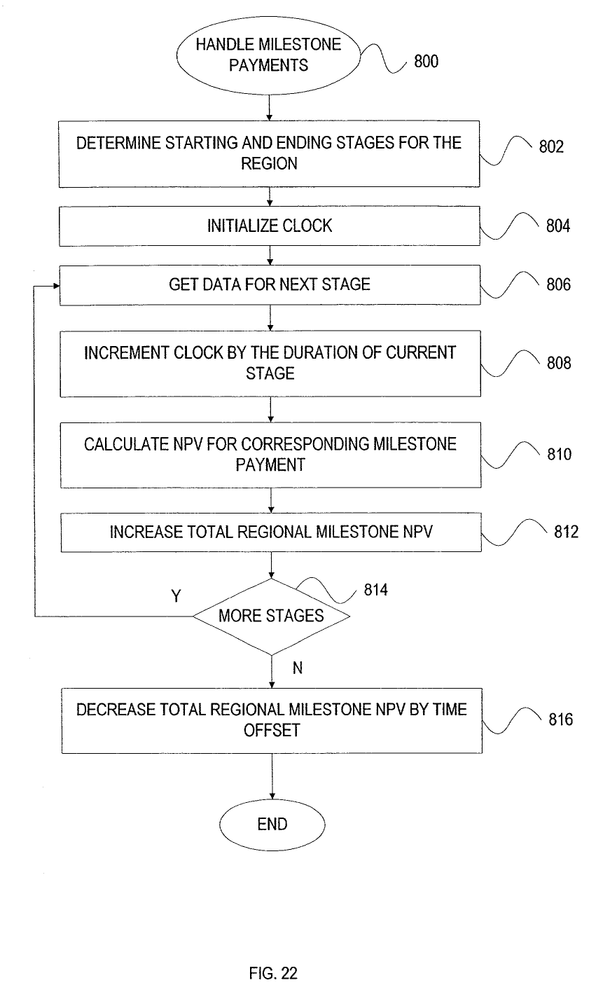

FIG. 22 is a flow diagram of a process 800 for handling milestone payments. As described above in connection with FIG. 9, evaluation system 100 may provide regional milestone payment schedules corresponding to milestone payments that occur in connection with the completion or initiation of specific development stages (for purposes of this example, milestone payments are triggered upon the completion of a given stage). Process 800 may be performed by evaluation system 100 during alliance evaluation process 300 (see FIG. 15). For example, process 800 may be employed during the calculation of the partnered precommercial NPV for the second entity (see task 314). In this regard, process 800 may be performed in an iterative manner.

Briefly, evaluation system 100 performs process 800 for any region included in the proposed alliance. Process 800 calculates a milestone payment NPV for each region, and the milestone payment NPVs are utilized to determine the overall NPVs for the current iteration.

During a task 802, evaluation system 100 may determine the starting and ending development stages for the region's development timeline (see the above description of task 310). For example, the development timeline for the current iteration may correspond to a successful development wherein all stages are successfully completed. On the other hand, the development timeline may correspond to a failed program wherein only the first three development stages are successfully completed. The starting development stage may represent any one of the development stages recognized by evaluation system (the user may designate the current development stage in the Run worksheet). Once the starting and ending stages have been identified, evaluation system 100 may initialize a clock (task 804) that represents the overall time duration from the start of the development to the milestone event (e.g., the completion of a specific development stage). Thereafter, evaluation system retrieves the alliance data for the next successfully completed development stage (task 806). During task 806, evaluation system 100 may identify the current development stage, the dollar amount of the corresponding milestone payment, the start and end times of the current development stage, the duration of the current development stage, and/or retrieve other data relevant to the calculation of the milestone payment NPV.

Continuing, evaluation system 100 increments the clock by the duration of the current development stage (task 808). Thus, the clock value accumulates with each iteration of task 808, which enables evaluation system 100 to determine when the current milestone payment is awarded. Next, evaluation system 100 calculates an NPV for the corresponding milestone payment (task 810). The preferred practical embodiment utilizes the lump-sum NPV calculation for this purpose. Evaluation system 100 increases the total milestone payment NPV for the particular region (task 812) by the NPV calculated in task 810.

If additional successful development stages remain (query task 814), then process 800 is reentered at task 804. Evaluation system 100 uses this processing loop to sum the individual milestone NPV contributions. Eventually, evaluation system 100 decreases the total milestone payment NPV for the region according to the regional time offset defined in the regional development assumptions worksheets (see above description of FIG. 4). The total milestone payment NPV for each respective region contributes to the overall NPV determinations described above in connection with FIG. 15.

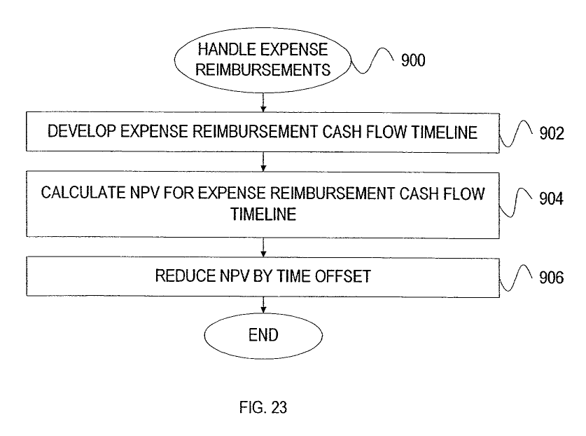

FIG. 23 is a flow diagram of a process 900 for handling expense reimbursements. As described above in connection with FIG. 10, evaluation system 100 may provide regional expense reimbursement schedules corresponding to reimbursements that occur in connection with specific development stages. Process 900 may be performed by evaluation system 100 during alliance evaluation process 300 (see FIG. 15). For example, process 900 may be employed during the calculation of the partnered precommercial NPV for the second entity (see task 314). In this regard, process 900 may be performed in an iterative manner.

Evaluation system 100 performs process 900 for any region included in the proposed alliance. Process 900 calculates an expense reimbursement NPV for each region, and the expense reimbursement NPVs are utilized to determine the overall NPVs for the current iteration.

Process 900 begins with a task 902, during which evaluation system 100 develops an expense reimbursement cash flow timeline using the region's development timeline, the cash bum rates for each development stage in the region, and the reimbursement rates contained on the respective expense reimbursement worksheet. Next, evaluation system 100 calculates an expense reimbursement NPV for the expense reimbursement cash flow timeline (task 904). In the preferred embodiment, evaluation system 100 employs the rate-based NPV formula to calculate the expense reimbursement NPVs.

Eventually, evaluation system 100 reduces the expense reimbursement NPV for the region according to any regional time offset defined in the regional development assumptions worksheets (see above description of FIG. 4). The total expense reimbursement NPV for each region contributes to the overall NPV determinations described above in connection with FIG. 15.

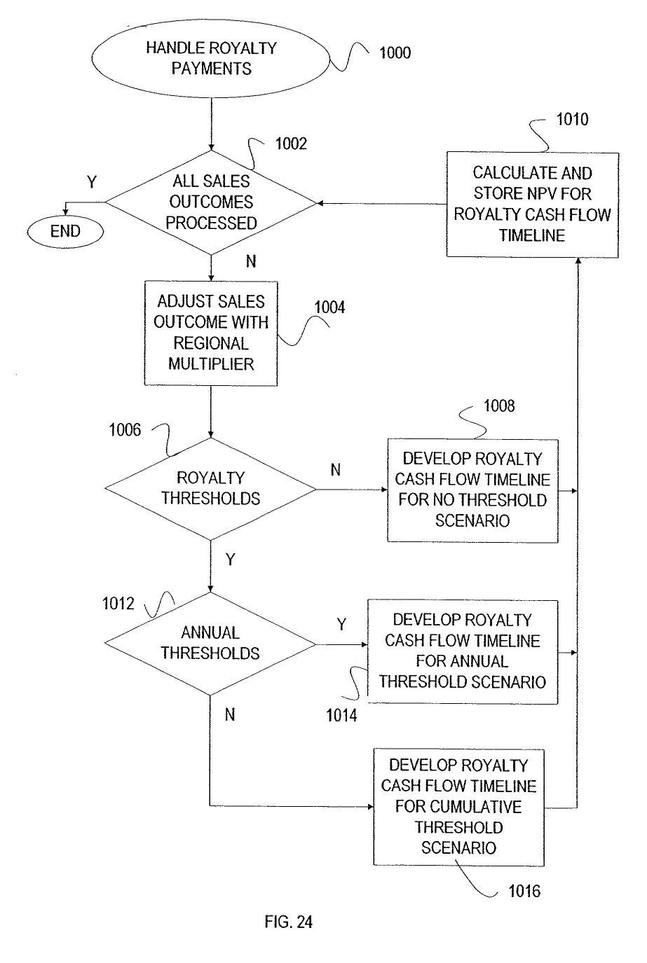

FIG. 24 is a flow diagram of a process 1000 for handling royalty payments. As described above in connection with FIG. 11, evaluation system 100 may provide regional royalty payment schedules corresponding to royalty payments that occur in the different regions. Process 1000 may be performed by evaluation system 100 during alliance evaluation process 300 (see FIG. 15). For example, process 1000 may be employed during the calculation of the partnered postcommercial NPV for the R&D entity (see task 306). In this regard, process 1000 may be performed in an iterative manner.

Evaluation system 100 performs process 1000 for any region included in the proposed alliance. For a given region, evaluation system 100 calculates a royalty payment NPV for each possible sales outcome. Accordingly, if evaluation system 100 has already processed all of the possible sales outcomes (query task 1002), then process 1000 ends. If not, then evaluation system 100 adjusts the cash flow timeline for the current sales outcome (task 1004) with the respective regional sales multiplier contained in the Sales Assumptions worksheet (see FIGS. 5 and 6). The cash flow timeline represents the sales characteristics (either simulated or flat) for the current sales outcome, as defined in the Sales Assumptions worksheet.

If no royalty thresholds are applicable (query task 1006), then evaluation system 100 develops a royalty payment cash flow timeline for the “no threshold” scenario (task 1008). As described above in connection with FIG. 11, the “no threshold” scenario can be easily defined by a single royalty rate. After the royalty payment cash flow timeline has been determined, evaluation system 100 calculates and stores the royalty payment NPV corresponding to the royalty payment cash flow timeline (task 1010). The preferred practical embodiment of evaluation system 100 employs the rate-based NPV formula during task 1010. Following task 1010, process 1000 is reentered at query task 1002.

If annual royalty thresholds are applicable (query task 1012), then evaluation system 100 develops a royalty payment cash flow timeline for the “annual threshold” scenario (task 1014). The “annual threshold” royalty timeline may consider a plurality of royalty rates in any given year. Whenever a royalty threshold is met, the current year is divided to accommodate the multiple royalty rates. Thus, evaluation system 100 creates multiple time periods corresponding to multiple royalty rate terms. Ultimately, evaluation system 100 calculates and stores the royalty payment NPV corresponding to the “annual threshold” royalty timeline (task 1010).

A negative output from query task 1012 represents the situation where cumulative royalty thresholds govern the royalty payment cash flow timeline. In this case, evaluation system 100 develops a royalty payment cash flow timeline (task 1016) according to the cumulative threshold terms set forth in the Royalty Payments worksheet. As mentioned above, evaluation system 100 divides the current year into multiple time periods to accommodate the different threshold royalty rates. Evaluation system 100 processes the “cumulative threshold” royalty timeline to calculate and store the corresponding royalty payment NPV (task 1010).

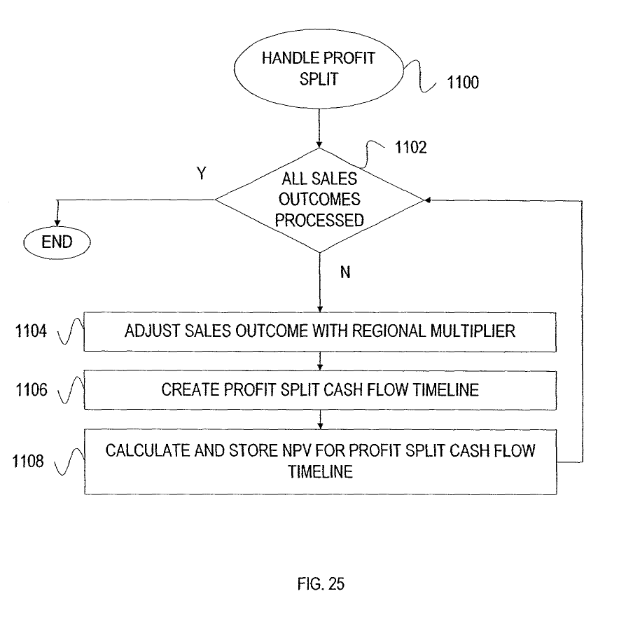

FIG. 25 is a flow diagram of a process 1100 for handling profit splitting terms. As described above in connection with FIG. 12, evaluation system 100 may provide regional profit split schedules corresponding to profit splitting arrangements in the different regions. Process 1100 may be performed by evaluation system 100 during alliance evaluation process 300 (see FIG. 15). For example, process 1100 may be employed during the calculation of the partnered postcommercial NPV for the R&D entity (see task 306). In this regard, process 1100 may be performed in an iterative manner.

Evaluation system 100 performs process 1100 for any region included in the proposed alliance. For a given region, evaluation system 100 calculates a profit split NPV for each possible sales outcome (profit splitting amounts are dependent upon the sales figures and the contribution margin). Accordingly, if evaluation system 100 has already processed all of the possible sales outcomes (query task 1102), then process 1100 ends. If not, then evaluation system 100 adjusts the cash flow timeline for the current sales outcome (task 1104) with the respective regional sales multiplier contained in the Sales Assumptions worksheet (see FIGS. 5 and 6). The cash flow timeline represents the sales characteristics (either simulated or flat) for the current sales outcome, as defined in the Sales Assumptions worksheet.

Next, evaluation system 100 creates a profit split cash flow timeline (task 1006) based on the sales outcome. For example, sales periods from the sales outcome cash flow timeline are divided if a profit split period ends during a sales period. The size of the profit split cash flow is calculated by multiplying the value in the respective “Take” field (see FIG. 12) by the sales cash flow for that period, as adjusted by the contribution margin. After the profit split cash flow timeline has been determined, evaluation system 100 calculates and stores the corresponding profit split NPV (task 1108). The preferred practical embodiment of evaluation system 100 employs the rate-based NPV formula during task 1108. Following task 1108, process 1100 is reentered at query task 1102.

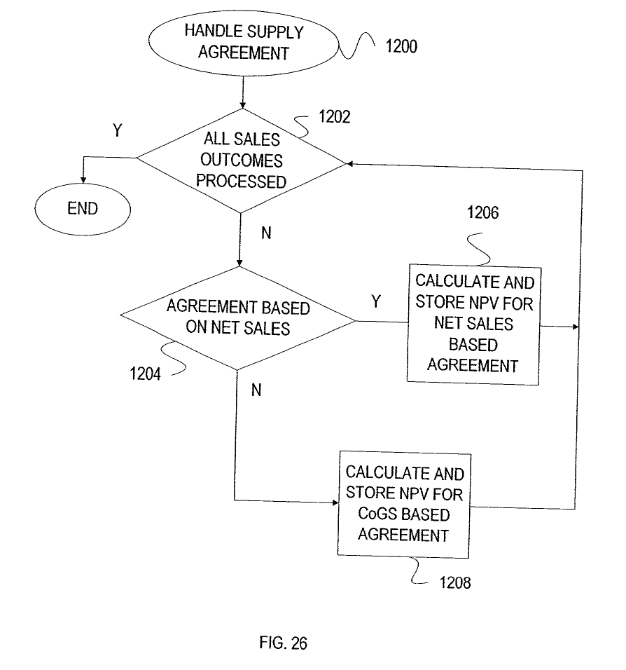

FIG. 26 is a flow diagram of a process 1200 for handling supply agreement terms. As described above in connection with FIG. 13, evaluation system 100 may provide regional supply agreement schedules corresponding to supply agreements that cover the different regions. Process 1200 may be performed by evaluation system 100 during alliance evaluation process 300 (see FIG. 15). For example, process 1200 may be employed during the calculation of the partnered postcommercial NPV for the R&D entity (see task 306). In this regard, process 1200 may be performed in an iterative manner.

Evaluation system 100 performs process 1200 for any region included in the proposed alliance. For a given region, evaluation system 100 calculates a supply agreement NPV for each possible sales outcome (the supply agreement terms may be dependent upon the sales figures). Accordingly, if evaluation system 100 has already processed all of the possible sales outcomes (query task 1202), then process 1200 ends. If not, then evaluation system 100 determines the type of supply agreement under consideration.

If the supply agreement for the current region is based on net sales figures (query task 1204), then evaluation system 100 calculates and stores an NPV for the net sales based agreement (task 1206). For the example embodiment described herein, this NPV is calculated by retrieving the unpartnered postcommercial NPV for the current sales scenario (see task 304 in FIG. 15), multiplying it by any applicable regional multiplier from the Sales Assumptions worksheet (see FIGS. 5 and 6), and multiplying it by the rate specified on the Supply Agreement worksheet (see FIG. 13). Thereafter, the cost of goods sold (which is calculated by multiplying the sales figures by a CoGS rate) is subtracted from the NPV. This CoGS rate may be a default value that is hidden from the user, or it may be a value entered by the user. After making this calculation, process 1200 is reentered at query task 1202.

A negative output of query task 1204 represents the situation where the supply agreement is CoGS-based. In this case, evaluation system 100 calculates and stores an NPV for the CoGS-based agreement (task 1208). For the example embodiment described herein, this NPV is calculated by retrieving the unpartnered postcommercial NPV for the current sales scenario, multiplying it by any applicable regional multiplier from the Sales Assumptions worksheet, multiplying it by the cost of goods sold for the sales outcome, and multiplying it by the CoGS rate specified on the Supply Agreement worksheet. As described above, evaluation system 100 also subtracts the computed cost of goods sold from this NPV. After making this calculation, process 1200 is reentered at query task 1202. Determination of Net Present Value

When evaluation system 100 executes, it randomly constructs a new product development program each time the model cycles. Evaluation system 100 then uses the development, sales and deal assumptions to determine a cash stream for each of the deal partners. Finally, evaluation system 100 reduces the cash stream to an overall NPV. As described above, evaluation system 100 may calculate a number of component NPVs corresponding to different income and expense scenarios, development assumptions, sales assumptions, and alliance structure components. A given NPV may be based on a lump-sum formula or a rate-based formula.

In the context of the present invention, a cash stream is a schedule of money received and paid over time. The NPV of a cash stream represents today's value of that stream under the assumption that cash received or paid in the future has less value than it has today. Every time evaluation system 100 creates a new simulated drug development program, it creates a schedule of all the money flowing in and out of the project as development expenses are paid, partnership obligations are fulfilled, and revenues are received.

Evaluation system 100 identifies at least two types of cash events and calculates NPVs differently for each type. A lump-sum payment is cash received or paid in a single event at a single point in time. For example, milestone and guaranteed payments are paid in lump sums. A rate-based payment is cash that is received or paid at a rate for a period of time. For example, Phase III clinical costs that are expended at a known annual rate during a particular span of time are rate-based payments.

A common formula for computing an NPV assumes that a payment, P, is received in the future as a lump sum:

$$NPV = \frac{P}{{( 1 + r )}^{t}}$$

In this case, r represents the periodic cost of capital and t represents the number of periods before payment. For instance, if r represents the annual cost of capital then t must indicate the number of years that elapse before payment is received.

Evaluation system 100 uses a slightly different formula for computing the NPV of a lump sum because the formula will be much easier to work with to derive a method for finding NPVs for rate-based payments. In the above formula, r could be an annual cost of capital. In that case, t is expressed in years, and the cost of capital is compounded annually. The rate, r, could just as easily represent a monthly cost of capital, which would mean that t is expressed in months and the cost of capital is compounded on a monthly basis. In this case, the monthly rate is one-twelfth of the annual rate. The NPV formula used by evaluation system 100 is derived by reducing the basis period until it is infinitesimally small and applying L'Hopital's rule from calculus:

NPV=Pe^{-rt}

As above, P represents the size of the lump-sum payment, r represents the annual cost of capital, and t represents the passage of time in years. Using this formula is the equivalent of compounding the cost of capital continuously rather than periodically.

Sometimes it is inconvenient to think of money as arriving and leaving in lump-sum units. For instance, evaluation system 100 allows the user to estimate that Phase III clinical trials will cost $10 million per year. It would be extremely difficult to account for exactly when each of the individual expenditures comprising the $10 million will occur. A good approximation is to assume the $10 million is expended at a constant rate throughout the course of the year. Evaluation system 100 utilizes this approximation whenever money is paid at a rate over a period of time.

One can describe a general flow of money with a function P(t) that returns the amount of money flowing at a particular time t. The cash flow can be divided into an infinite number of tiny lump sums, the NPV of each lump sum can be calculated, and the total NPV can be summed according to the following formula:

$$NPV = {\int }_{T1}^{T2} P ( t ) {ⅇ}^{- rt} ⅆ t$$

In the case where cash flows at a constant rate A, the above integral is relatively easy to solve:

$$NPV = {\int }_{T1}^{T2} {Ae}^{- rt} ⅆ t = \frac{A}{r} ( {ⅇ}^{- rT1} - {ⅇ}^{- rT2} )$$

Suppose we want to calculate the NPV of a Phase II clinical trial that we expect will begin in two years. The trial will last one year and nine months (1.75 years) and it will burn $7 million per year. Assume that the cost of capital is 10%. The NPV is easily calculated by substituting the appropriate values into the above formula:

$$NPV = \frac{7}{0.10} ( {ⅇ}^{- ( 0.10 ) ( 2 )} - {ⅇ}^{- ( 0.10 ) ( 3.75 )} ) = \$9 .20 million$$

One advantage of using the exponential method for computing the NPV is that the above equations obey the property of superposition:

Pe^{-r(T1+T2)}=e^{-rT2}(Pe^{-rT1})

Suppose the above Phase II trial is to begin in four years rather than in two years as presumed in the previous calculation. Instead of recalculating the entire NPV, the previously calculated value can be adjusted by two years:

NPV=e^{-(0.10)(2)}(0.920)=0.753=$7.53 million

Superposition allows evaluation system 100 to pre-calculate the NPV of a complicated cash flow, such as the sales revenue stream, and then adjust the NPV to accommodate time offsets and time delays associated with the simulated development and sales timelines for a proposed product.

Example Application

The features and functionality of the present invention will be described in detail in the context of a demonstration of an example evaluation system (from the perspective of the end user of a client device). As mentioned above, the client-side program code segments can be realized as a Java applet that executes when the end user accesses a particular web page on the client web browser. The example set forth herein represents a typical biotechnology industry strategic alliance for the development of a new drug. The evaluation system performs iterative processing to simulate repeated attempts at developing a drug according to probabilistic functions that govern the development time, development success, and commercial success of the drug. For each attempt, the system tracks the cash flowing in and out of the project as expenses are paid, revenues are received, and partnership obligations are fulfilled. The individual cash flows are then reduced to a net present value (NPV) and the distribution of NPVs is analyzed to ultimately indicate the value of the drug development program (which may be partnered or unpartnered).

The client-side component of the evaluation system provides an easy-to-use interface for specifying a number of parameters that characterize the structure of a strategic alliance. For example, financial terms of an alliance may be conditional upon the satisfaction of certain development milestones. In addition, these parameters may represent cost estimates associated with the development of a product, the risk of failure in different stages of the development, and the potential financial benefit should the product be successfully developed and brought to market. As depicted in FIG. 2, when the evaluation system is running, four tabs are displayed as part of the user interface. These tabs include Deal Structure tab 132, Development Assumptions tab 134, Sales Assumptions tab 136, and Run tab 138. These tabs serve as data entry points to each major part of the simulation model. For example, Deal Structure tab 132 enables the user to specify the terms of a strategic alliance, Development Assumptions tab 134 allows the user to characterize the cost structure of a drug development project using a cost worksheet, Sales Assumptions tab 136 allows the user to estimate how well the drug will sell, and Run tab 138 enables the user to describe global processing parameters such as the cost of capital and the percentage probability of success at each development stage. Each of these features is described in more detail below.

Iterative Processing

The evaluation system employs an iterative processing technique to determine the aggregate outcome of probabilistic functions that may be too complicated to combine analytically. In the preferred embodiment, the evaluation system determines the fate of a drug development program each time it performs a simulation iteration. For instance, one randomly driven probabilistic function may determine how long the drug spends in Phase I clinical trials. Another random probabilistic function may determine whether the drug completes Phase I and continues to Phase II trials. If the drug passes FDA approval, yet another random probabilistic function may determine how well the drug performs on the market.

Once the evaluation system has determined the fate of the drug program for a given iteration, the evaluation system will consult the development cost assumptions, the sales assumptions, and the deal structure components previously entered by the user. The evaluation system uses these parameters to calculate NPVs for the partnered drug development program for each alliance partner. These NPVs are then stored in memory while the evaluation system randomly simulates another development program. After a number of iterations (e.g., a few thousand cycles), the resulting distribution describes the possible NPVs for the development program and the relative chances of achieving them.

Probabilistic Functions

Probabilistic functions serve three purposes in the simulation model. They determine the length of time a drug spends in a development stage, they determine whether a development stage is successfully completed, and they determine the commercial success of a drug if it arrives on the market.

In the strategic alliance evaluation model, the development of a drug is preferably divided into a number of stages (e.g., Discovery, Target Validation, Preclinical, IND Filing, Phase I, Phase II, Phase III, and NDA Filing). Each stage can be characterized by a cash burn rate that is set in the Development Assumptions panel of the user interface. For each analytical iteration performed by the evaluation system, the first step in creating a simulated drug program is to find the duration of the first development stage. In this regard, the evaluation system generates a random number and passes it to a probabilistic function, which returns a duration for that stage. The evaluation system may utilize generic, preset stage duration functions or it may dynamically derive the functions using information culled from a clinical trials or historical database. When a stage duration is long, the developing company or entity spends more money, and potential revenues are delayed. Consequently, longer stage durations decrease the program's NPV.

The evaluation system also uses probabilistic functions to determine how far a particular drug simulation will travel through the development process (thus randomly simulating successes and failures at different developmental stages). The end user can dictate the likelihood of successfully completing each development stage in the Run panel of the user interface. At the completion of each development stage in a simulation, a random number may be generated and compared to the success likelihood for that stage. If the comparison is unfavorable, the development program fails at that point in time. If the comparison is favorable, the evaluation system determines the duration of the next development stage and whether the next stage is successful. This procedure continues until the development program either fails or successfully completes all of the remaining development stages.

Finally, if the drug successfully completes all the development stages in a simulation, probabilities determine the degree of market success for the drug. To this end, the end user can create a number of potential sales scenarios under Sales Assumptions tab 136. For example, the user can set the drug's product lifetime, peak annual sales, and contribution margin for different sales scenarios. The user can also set the relative probability of each scenario occurring. When a simulated drug is successfully developed, the evaluation system randomly chooses a sales scenario according to the relative probabilities. The cash stream from the selected scenario becomes the basis for the post-commercial NPV calculations.

Development Assumptions

In a typical biotechnology industry strategic alliance, the partners share the risk of developing a drug and share in the reward if the drug succeeds on the market. The value of these alliances must therefore be evaluated in the context of the cost structure of the partnered drug development project. The evaluation system allows the end user to enter the projected costs of the drug development program using Development Assumptions tab 134.

FIG. 3 depicts a sample Research Region Development Assumptions worksheet 142 accessible via Development Assumptions tab 134. On various worksheets accessible via Development Assumptions tab 134, cost values are entered as cash bum rates. Cost values are expressed in millions of dollars per year and they describe how quickly the R&D company will spend money during each of the drug's various development stages. When the evaluation system executes, it randomly determines the duration of each development stage for each iteration. The method of determining these durations is described in more detail below.

Once a development schedule has been determined for a particular iteration, the evaluation system uses the cash burn rates to calculate the development NPV for that iteration. For instance, assume that $10 million has been entered for the annual development costs during Phase III clinical trials, and that the system randomly determines (for one of the iterations) that Phase III lasted 2.5 years. For that iteration, the system will calculate the development NPV as if $25 million had been evenly expended throughout these 2.5 years.

Geographic Regions

In many drug development programs, the research will occur in one geographical region, such as the United States. However, separate clinical trials may be conducted in other regions, such as Europe or Asia, before the drug is sold in those areas. In addition, strategic alliances often have regional components. For instance, an R&D company may grant to a pharmaceutical company an exclusive license to market a drug worldwide, excluding Asia and North America. The two companies may co-promote the drug in North America, and an Asian license may be sold to a third party.

Regional variations in development costs can also be designated using a worksheet accessible from Development Assumptions tab 134. In the example embodiment described herein, evaluation system 100 accommodates three regional worksheets corresponding to the research, second, and third regions (the research region is considered to be the primary region). Research Region Development Assumptions worksheet 142 shown in FIG. 3 represents the research or primary region, while FIG. 4 depicts an example Second Region Development Assumptions worksheet 144 for the second region (the worksheet for the Third region is similar). Only one worksheet is visible at a time, with the research region showing by default. A selection menu 170 allows the user to move between the three regional development cost worksheets.

Research Region

The research region is the geographic region where the majority of early-stage development costs occur. As shown in FIG. 3, for each development stage, costs in the research region are preferably organized into four categories: R&D, Clinical, Sales, and Manufacturing. A “G&A Rate” field 172 represents the percentage administrative overhead costs associated with the project. A number of “Totals” fields 174 displays the total cash bum rate for each of the development stages. The evaluation system calculates the total annual cash bum rates by adding the four categorized values for a development stage. A G&A value is then added to the sum to obtain a total. This G&A value is the result of multiplying the G&A rate times the sum of the R&D, Clinical, and Sales cost categories.

The end user can enter estimated development costs for the research development region in the appropriate fields in Research Region Development Assumptions worksheet 142. The total for a development stage is updated automatically to reflect any changes to the categorized costs for that stage. In addition, the evaluation system recalculates all of the totals in response to any changes to the G&A rate.

When the evaluation system calculates the development NPV of the research region, it disregards cost categorization. Thus, in the example embodiment, the only relevant values in calculating the research region development NPV are the totals for each development stage. In an alternate version of the evaluation system, the end user can specify which cost categories will be reimbursed by the client partner in an alliance. In the example embodiment described herein, costs are categorized in the research region to simplify the entering of cost estimates in the secondary regions.

Secondary Regions

Early-stage drug development does not typically occur in secondary regions. Suppose a drug was invented and initially developed in the United States. If the drug undergoes separate clinical trials in Europe and Asia, Europe and Asia would be considered secondary regions. As mentioned above, the evaluation system provides secondary region development cost worksheets for a second region and a third region. Both secondary region worksheets contain the same elements (see FIG. 4). A number of “Totals” fields 188 list the total cash burn rate for each of the development stages. The evaluation system uses these totals when it calculates the development NPV for a secondary region. A number of “Multiplier” fields 176 allow the user to insert a multiplier that affects the respective values in “Totals” fields 188.

Costs in the secondary regions are entered as multiples of the costs in the research region, by cost category. For example, the end user would enter 1.2 in a “Clinical” field 180 of Second Region Development Assumptions worksheet 144 to reflect an estimate that the clinical costs in that region will be 20% greater than they are in the research region. In this case, the evaluation system multiplies the clinical expense entry for each development stage in the research region by 1.2 and adds it to the “Totals” field for the corresponding development stage in the second region.

Usually, most of the R&D category costs are incurred in the early development stages in the research region. These R&D costs typically do not occur in the secondary regions, so the R&D cost multipliers in the secondary regions are usually set to zero. This results in zero total cash burn in the secondary regions at the early development stages.

A “G&A Rate” field 186 in Second Region Development Assumptions worksheet 144 represents the overhead costs of the development project. As in the research region, this rate increases only the R&D, Clinical, and Sales costs.

Development in the secondary regions usually lags behind development in the research region. The duration of this delay is set in a “Time Offset” field 190. As an example, if development in the research region enters the Phase II stage, and the time offset in the second region is one year, development in the second region will enter Phase II one year after Phase II development started in the research region. Termination of a development program is determined in the research region. Thus, when a drug development program terminates in the research region, it immediately terminates in the second and third regions.

Determination of Stage Durations

When the evaluation system executes, the duration of each development stage is randomly determined for each iteration cycle when the development program enters a new stage in the research region. Corresponding stage durations in the secondary regions will match those in the research region except in the final stage if the program terminates prior to FDA approval.

In the example system described herein, the stage duration function is generic and simplified. Alternatively, the stage duration functions can be dynamically calculated by drug category using information contained in a clinical trials database. Table 1 illustrates the possible durations of each stage according to the simplified model.

TABLE
Development Stage Duration Probabilities

| | One Year | Two Years | Three Years | Four Years |
|---|---|---|---|---|
| Discovery | 100% | | | |
| Validation | 85.5% | 9.5% | 5% | |
| Preclinical | 100% | | | |
| IND Filing | 85.5% | 9.5% | 5% | |
| Phase I | 100% | | | |
| Phase II | 85.5% | 9.5% | 5% | |
| Phase III | | 85.5% | 9.5% | 5% |
| NDA Filing | | 85.5% | 9.5% | 5% |

Success Probabilities

At the conclusion of each development stage in an iteration cycle, the evaluation system randomly determines whether the development program continues to the next stage or terminates. The probability of successfully completing each development stage is entered as a percentage in Run worksheet 164 (see FIG. 14). In Run worksheet 164, the likelihood of successfully completing each development stage is listed in a respective data entry field.

If a development program successfully completes all of the development stages for the current iteration, the evaluation system will randomly determine how well the drug performs on the market according to the sales assumptions previously entered by the user. These sales assumptions are described in more detail below.

Sales Assumptions

When a new drug developed under an alliance arrives at market, the partners will share the revenues according to the terms of their strategic alliance. The size of this revenue stream plays a critical role in determining the NPV of the partnered drug development program. When the evaluation system executes, it repeatedly attempts to randomly develop the proposed drug. If a simulated drug development program successfully completes all of the development stages in an iteration, the evaluation system randomly retrieves a sales outcome in accordance with the settings specified in one of the Sales Assumptions worksheets (see FIGS. 5 and 6).

Sales Curves

The evaluation system allows the user to characterize the sales performance of the drug by creating a family of sales curves. Each curve describes a possible scenario for the product's lifetime sales in the research region. For instance, one curve could represent a worst-case scenario and have a relatively short product lifetime, low peak sales, and a small contribution margin. Two more curves could represent a most likely sales scenario, and a best-case scenario.

Each sales curve has some relative probability of occurring. For example, the user may assign a 15% chance to the worst-case scenario occurring, a 70% chance to the most-likely scenario, and a 15% chance to the best-case scenario. If the drug development program completes all of the development stages in an iteration, then the evaluation system randomly retrieves one of the three sales curves according to these probabilities.

The client application currently supports two methods of describing sales outcomes. Simulated sales curves are utilized if the user selects the “Simulated Sales Curves” option. These sales cures are good approximations of actual product lifetimes. Values, such as the total annual sales, ramp up and down as the product matures. On the other hand, flat sales curves are more adjustable, but less realistic. Alternatively, the sales function may be dynamically calculated using information obtained from a historical database of actual drugs that have successfully gone to market.

Simulated Sales Curves

The simulated sales curves are realistic in their complexity. An example Simulated Sales worksheet 146 is depicted in FIG. 5. For the simulated sales curves, the total annual sales increase to a peak value and then decrease as the product matures. Another feature of these curves is that the contribution margin is different for each curve and it changes with time. The evaluation system uses these curves when the user selects the “Simulated Sales Curves” option.

Five different curves make up the family of simulated sales curves in the research region. These curves are named Blockbuster, Above Average, Average, Below Average, and Dog. The user can adjust the scale of any curve by changing the peak annual sales values in any of the corresponding fields. The curves describe sales in the research region only, and the peak value should reflect the expected peak annual sales in that region only.

Sales in the secondary regions are expressed as multiples of those in the research region. The user can enter these multipliers in a “2^{nd} Region Multiplier” field 192 and a “3^{rd} Region Multiplier” field 194. For example, if the development assumptions have been entered as though the United States is the research region and Europe is the second region, and the expected sales in Europe will be 20% greater than those in the United States, then 1.2 should be entered in the “2^{nd} Region Multiplier” field 194. If expected peak sales in the United State are estimated at $100 million, then the estimated peak sales would reach $120 million in Europe. However, because development in a secondary region can be offset in time from development in the research region, peak sales in Europe may lag behind peak sales in the United States by the offset time.

Simulated Curve Characteristics

One distinguishing feature of the simulated curves is that annual sales ramp up to a peak value and then diminish to zero over a fifteen-year product lifetime. As shown in FIG. 5, the user can set the peak value for each curve using the five fields provided on Simulated Sales worksheet 146. Table 2 illustrates the percentage of the peak sales that is booked in each year of the product lifetime for the five curves.

TABLE 2
Product Lifetime For Simulated Sales Curves

| Year | 1 | 2 | 3 | 4 | 5-7 | 8-9 | 10-12 | 13-15 |
|---|---|---|---|---|---|---|---|---|
| % | 40 | 55 | 70 | 85 | 100 | 83 | 58 | 30 |
| of peak | | | | | | | | |

Another value that changes with time is the contribution margin. The contribution margin is the excess of a drug's sales price over the variable costs associated with producing and selling it. Multiplying the contribution margin and the annual sales for a period returns an inward cash flow that contributes positively to the development program's NPV. For the simulated sales curves, the contribution margin increases during the first five years of product sales and it differs for each curve. Table 3 illustrates how the contribution margin changes for each curve.

TABLE 3
Contribution Margins for Simulated Sales Curves

| | Year 1 | Year 2 | Year 3 | Year 4 | Years 5-15 |
|---|---|---|---|---|---|
| Blockbuster | 25% | 30% | 40% | 40% | 50% |
| Above Ave. | 20% | 25% | 30% | 40% | 40% |
| Average | 15% | 20% | 25% | 35% | 40% |
| Below Ave. | 10% | 15% | 20% | 30% | 35% |
| Dog | 5% | 10% | 15% | 25% | 30% |

Each sales curve has a different relative probability of being selected if the drug arrives at market. In the example embodiment, these probabilities are fixed for the simulated family of sales curves. These probabilities are as follows: Blockbuster (15%); Above Average (20%); Average (30%); Below Average (25%); and Dog (10%). FIG. 5 shows these probabilities in parentheses next to the respective sales curve.

Flat Sales Curves

A second method of creating sales curves gives the user more flexibility in setting parameters. When the user creates a flat sales curve, he can specify the annual sales, the product lifetime, the contribution margin, and the relative probability of the curve being selected by the system. While flat sales curves are more adjustable than the simulated sales curves, they are less realistic; neither the sales volume nor the contribution margin varies with time. FIG. 6 depicts an example Flat Sales worksheet 148 that is generated in response to the selection of the “Flat Sales Curve” option. As shown, five rows of fields in the center of Flat Sales worksheet 148 correspond to five sales scenarios that can be created with Flat Sales worksheet 148. The user can designate up to five sales curves, the sales figures associated with each curve, and the probability of occurrence for each curve.

Flat Curve Characteristics

As with the simulated sales curves, the user has the ability to set the drug's annual sales for each flat sales curve. However, the annual sales for the flat curve do not change from one year to the next as they do for the simulated curves, i.e., they remain constant for the lifetime of the drug. Thus, the user should enter a sales value corresponding to the estimate for the average annual sales in the research region for a sales scenario.

Sales in the secondary regions are expressed as multiples of the sales in the research region using a “2^{nd} Region Multiplier” field 204 and a “3^{rd} Region Multiplier” field 206. For example, if sales in the second region are expected to be 10% less than they are in the research region, then 0.9 should be entered in “2^{nd} Region Multiplier” field 204. When the evaluation system selects a sales curve for the research region at the conclusion of a successful iteration, it will use the same curve, scaled by a regional multiplier, to calculate the post-commercial NPV in a secondary region when the drug arrives at the market in that region.

The user can also set the relative probability of each flat sales curve being selected by the system. These probabilities are stored in a number of “Odds” fields 196 in Flat Sales worksheet 148. The odds for all the active curves must always combine to 100%, because one of the curves must always be chosen in a successful iteration. Whenever a new value is entered in an Odds field, the evaluation system will update the other odds values to ensure that they total 100%.

A number of “Lifetime” fields 200 determine the duration of the drug's stay on the market. Increasing the product lifetime for a sales curve increases its contribution to the ultimate NPV.

Finally, the contribution margin is the excess of a drug's sales price over the variable and direct fixed costs associated with producing and selling it. Multiplying the contribution margin and the gross sales for a period returns a cash inflow that contributes to the NPV. In Flat Sales worksheet 148, the user can enter a specific contribution margin estimate for each sales curve using a number of “Margin” fields 202.

Alliance Structure

The evaluation system enables a user to compare the terms of two different strategic alliances. For example, the evaluation system can be used to compare a license agreement with a 15% royalty to an agreement having a 50/50 profit split. It also allows a user to determine whether a $1 million upfront payment is more desirable than a $5 million Phase III milestone payment. One notable feature of the system is its ability to capture specific strategic alliance financial terms and analyze them from the perspectives of both deal partners.

As mentioned above, when the evaluation system executes it repeatedly creates and values random drug development simulations. For each simulation iteration, the system calculates three NPVs. The unpartnered NPV includes only the development costs and sales revenues. This NPV represents the value of the simulated drug program in the absence of any strategic alliance.

The evaluation system also keeps track of the cash streams of the R&D entity and the client entity as partnership obligations are fulfilled. As the system randomly builds a drug development program in a cycle, it looks at the strategic alliance defined in Deal Overview worksheet 140 (see FIG. 2). If the development program encounters a scheduled pre-commercial alliance structural element, the appropriate amount of cash is removed from the client company's cash stream and added to the R&D company's cash stream. If the drug reaches the market at the end of a cycle, profits are divided between the revenue streams of both companies according to the post-commercial deal structure. As described in detail below, Deal Overview worksheet 140 allows the user to easily exchange an upfront payment for a milestone payment in otherwise identical deals and immediately observe the effect.

Deal Overview Worksheet

The financial terms of the strategic alliance can be entered via Deal Structure tab 132. By default, evaluation system 100 will display Deal Overview worksheet 140 when the user selects Deal Structure tab 132. Deal Overview worksheet 140 controls the scope of the deal under consideration. The checkboxes on Deal Overview worksheet 140 add regional coverage or structural elements to the alliance.

A number of regional checkboxes 166 rendered on Deal Overview worksheet 140 change the geographic scope of the deal. The evaluation system assumes that all development programs will be developed and sold in all three major market regions (although any given alliance may pertain to only one or any number of these regions). Consequently, development costs and sales revenues from all three regions are usually included in the results. To model a drug that will be developed and sold in only one or two regions, the user can zero out the development costs for the unwanted regions via the Development Assumptions worksheets and enter zero for the regional multipliers via the Sales Assumptions worksheets.

The regional checkboxes determine which regions are included in the alliance. Suppose that the user sets up the development and sales assumptions as though the research region represents North America, the second region represents Europe and the third region represents Asia. Assume that the user intends to co-promote the drug with a partner in North America and that the user wants to grant a license for the partner to market the drug in Asia. However, in Europe the user intends to develop and market the drug on his own. In this case, the user would select the “Research” region option and the “Third” region option on Deal Overview worksheet 140, indicating that Europe is not considered in the deal. Note that in this case, European development costs and sales figures are still included in the calculation; they are simply outside the scope of the strategic alliance.

Many of the deal structure elements, such as royalty payments, can be assigned by region. In these cases, the ability to modify structural elements for a region is blocked if the region is not selected in Deal Overview worksheet 140. Some of the deal structure elements, such as guaranteed payments, do not have a regional context. In these cases, time values in the alliance worksheets are relative to events in the research region.

The remaining seven checkboxes on Deal Overview worksheet 140 allow the user to select the seven structural elements in the alliance. When any of the four pre-commercial or three post-commercial structures are checked in Deal Overview worksheet 140, a corresponding entry will appear in a selection menu 168. Choosing one of these entries in selection menu 168 evokes a worksheet corresponding to the selected deal structure.

A distinction is made between pre-commercial and post-commercial structural elements in Deal Overview worksheet 140. Pre-commercial structures describe payments from the client company to the R&D firm during the drug's development. Commercialization rights granted to the client when the drug arrives on the market are post-commercial structures. Each of these structural elements is described in detail below.

Guaranteed Payments

Guaranteed payments are scheduled, lump-sum payments to the R&D company that are guaranteed to occur regardless of the progress of the drug development program. Guaranteed payments arrive as lump sums and the evaluation system uses the lump sum method of calculating guaranteed payment NPVs. A good example of a guaranteed payment is an upfront payment, which is cash paid upon signing an agreement. Such guaranteed payments can be scheduled in a Guaranteed Payments worksheet 150 (see FIG. 7), which is accessible via selection menu 168.

Guaranteed Payments worksheet 150 provides space to create two separate payment schedules. Pairs of fields for entering five separate payments are arranged horizontally for each schedule. Guaranteed Payments worksheet 150 allows the user to enter the payment amount (in millions of dollars) and the time that the payment is received. The time value represents when (in years) the payment is received relative to the commencement of a designated development stage. Each payment schedule has a selection menu 212 for the selection of the reference stage.

Selection menu 212 is realized as a dropdown menu that contains an entry for each of the stages of the drug development program. It also contains an extra entry marked “Current Stage.” When a user models a drug development program with the evaluation system, he can include the assumption that the drug has already achieved any of the designated development stages. If the “Current Stage” entry is selected, the payment schedule begins relative to the identified development stage, which is selected in Run worksheet 164. For example, it may be desirable to model a drug development program that is currently in Phase I clinical trials. In this case, the user would set the current development stage to Phase I in Run worksheet 164. Thereafter, if “Current Stage” is selected in a guaranteed payment schedule, the values entered in a number of “Time of Receipt” fields 210 will be relative to the start of Phase I clinical trials.

As an example guaranteed payment, suppose that the user is interested in analyzing the effect of including a $2 million upfront payment in an alliance. First, the user will add a guaranteed payment structure to the alliance by selecting the “Guaranteed Payments” checkbox in Deal Overview worksheet 140. Next, $2 million is entered in the first “Payment” field of the first guaranteed payment schedule. If the first “Time of Receipt” field is set to zero and selection menu 212 is set to “Current Stage,” then the payment will represent a $2 million upfront payment.

Suppose that in a more complicated alliance, a $4 million license fee will arrive in equal biannual payments for the two years following the signing of the deal. In this case, the user may continue to use the “Current Stage” setting for the schedule's starting point. However, the schedule becomes slightly more complex; the user will enter four $1 million payments with 0.0, 0.5, 1.0, and 1.5 as the corresponding time values.

As a condition for the R&D company to receive guaranteed payments in one of the iterations, the starting point for a guaranteed payment schedule must be reached by the simulation. For example, if a payment schedule starts relative to the commencement of Phase I and a drug program terminates in the Discovery stage of a particular iteration, no guaranteed payments will occur for that iteration. However, once the starting point is reached, the entire schedule will be paid. If a guaranteed payment is scheduled to occur ten years after the commencement of Phase I, the payment will be paid even if the program terminates during Phase II trials only two years after the beginning of Phase I.

As a final example, suppose an agreement includes $5 million in guaranteed payments. One million dollars will be disbursed upon signing as an upfront payment. The remaining $4 million is in payments that are contingent on the drug development program entering Phase I clinical trials. The payments will be disbursed in four equal biannual allotments. In this case, the upfront payment is reflected in the first guaranteed payment schedule by entering $1 million in the first “Payment” field, leaving zero for the value in the corresponding “Time of Receipt” field, and leaving selection menu 212 set to “Current Stage.” Next, the selection menu in the second guaranteed payment schedule is set to “Phase I.” Finally, four $1 million payments are entered in the first four “Payment” fields of the second schedule and the corresponding time values of 0.0, 0.5, 1.0, and 1.5 are entered.

The evaluation system handles a tricky case gracefully. Suppose a four year schedule starts relative to the commencement of Phase I, but the simulation is run with Phase II selected as the current stage in Run worksheet 164. In this case, the guaranteed payment schedule is relative to a starting point that has already occurred by the commencement of the simulation. The evaluation system knows that Phase I must have been previously reached. Consequently, it randomly determines the duration of the Phase I stage and includes all guaranteed payments remaining on the schedule at the commencement of Phase II. Sunk costs are not included in the NPV calculation, so payments scheduled prior to Phase II would be ignored in this case.

Sponsored Research

Sponsored research represents a commitment by the client company to underwrite research at the R&D company at a specific cash rate for a period of time. Sponsored research payments need not correspond to any particular use or expenditure. Therefore, like guaranteed payments, sponsored research payments may enrich the R&D company. Unlike guaranteed payments, sponsored research commitments typically end immediately if the drug development effort terminates. Sponsored research payments are expressed as cash rates by the evaluation system. Therefore, the system uses a rate-based NPV calculation to include sponsored research payments in the model.

The user can add a sponsored research structure to the proposed alliance by selecting the “Sponsored Research” checkbox in Deal Overview worksheet 140 (see FIG. 2). Thereafter, a Sponsored Research worksheet 152 (see FIG. 8) can be accessed via selection menu 168. Sponsored Research worksheet 152 can include up to five different finding levels. Entry fields for the five funding levels are arranged horizontally across Sponsored Research worksheet 152. Each funding level is grouped with fields for entering corresponding starting and ending times. For each funding level, the user enters the starting time, the ending time, and the amount of annual funding.

The starting and ending times for a sponsored research schedule are relative to the commencement of one of the designated development stages of the drug. For example, the strategic alliance may include an initial demonstration project having no sponsored research followed by a fully sponsored program for target validation. The evaluation system provides a selection menu 222 on Sponsored Research worksheet 152; selection menu 222 allows the user to choose which development stage will be the starting point for that schedule. Selection menu 222 contains an entry for each development stage of the drug program. It also contains an extra entry marked “Current Stage.” As described above, a simulation by the evaluation system can include the assumption that the drug development program has already achieved any one of the designated development stages. If “Current Stage” is selected, the sponsored research payment schedule begins relative to the starting development stage, which is selected in Run worksheet 164.

The funding level for a sponsored research schedule may be expressed as either an explicit cash rate (in millions of dollars per year) or as a number of full time equivalent (FTE) employees. This selection is made on Sponsored Research worksheet 152. If a cash rate is selected, then the user enters the funding level (in millions of dollars per year) in a “Rate” field 220. If FTEs are selected, then the user enters a number that represents the number of employees at the research company that will be supported by the client company. In addition, the user enters an FTE rate value, which describes the cost of funding a typical full time research employee in millions of dollars per year. Thus, rate-based funding at $1 million per year is equivalent to funding four FTEs at an FTE rate of $0.25 million per year.

Suppose that, as part of an alliance, the client company offers the R&D company five years of research sponsorship. The commitment will begin at the start of Target Validation and will last five years. The funding level will be $5 million per year for the first three years and will fall to $3 million for the remaining two years. This alliance can be adequately described using Sponsored Research worksheet 152. The user should select “Target Validation” as the starting point for the funding schedule. The user enters 0.0 for the starting time, 3.0 for the ending time, and $5 million per year for the cash rate in the leftmost column of the finding schedule. This indicates that the R&D company should receive $5 million per year for the three years after the start of Target Validation. For the second funding level, the user enters 3.0 as the starting time, 5.0 as the ending time, and $3 million per year as the cash rate.

Sponsored research payments commence when the drug development program reaches the earliest point defined in the funding schedule. Payments end when either the latest point defined in the funding schedule is reached or the development program fails. In the above example, the sponsored research payments will begin in a cycle if the development program starts the target validation stage. The payments will end five years later if the development program stays alive that long, but they will terminate immediately if the program fails before the five years is reached.

As mentioned above, the evaluation system allows the user to designate whether the program has already completed any of the designated development stages. If the starting point of the sponsored research schedule is before the starting point for the simulation, the evaluation system randomly determines the duration of all the development stages prior to that starting point (for each iteration) to determine if any part of the funding schedule should be included in the NPV for the current iteration. Sunk costs are not included in the NPV calculation, so payments prior to the starting point of the simulation are ignored.

Milestone Payments

Many strategic alliances include lump-sum payments to the R&D company when a drug development program meets specific goals. Milestone payments arrive in lump sums, so the evaluation system uses the lump-sum method to calculate their NPVs. To accommodate this feature, the evaluation system generates a Milestone Payments worksheet 154 (see FIG. 9), which is accessible from Deal Overview worksheet 140. Milestone Payments worksheet 154 includes data entry fields for eight development goals in each of the three regions. These development goals represent the successful conclusion of the eight development stages. If the entry fields are inactive for any of the regions, it is because that region has not been included in the proposed alliance (as described above, additional regions can be selected on Deal Overview worksheet 140).

Milestone Payments worksheet 154 allows the user to locate the field for the specific milestone and enter the size of the payment in millions of dollars. As an example, assume that an agreement includes $15 million in total milestone payments. The R&D company will receive $1 million if the Investigational New Drug (IND) application is filed in the United States. The R&D company will earn $2 million and $3 million, respectively, at the initiation of Phase III clinical trials and upon filing a New Drug Application in the United States. Finally, the R&D company will receive $4 million, $3 million, and $2 million upon regulatory approval in the United States, Europe, and Asia, respectively.

On Milestone Payments worksheet 154, the user will enter $1 million, $2million, $3 million, and $4 million, respectively, in the “NDA Filed,” “Phase III Initiation,” “NDA/PLA Filed,” and “Approval” fields in a Research Region schedule 224. Finally, the user will enter $3 million and $2 million, respectively, in the “Approval” fields in a Second Region schedule 226 and a Third Region schedule 228 on Milestone Payments worksheet 154.

A milestone payment for a particular development goal will be awarded to the R&D company at the successful conclusion of the corresponding development stage in an iteration. The development stage is deemed successful if the development program does not terminate at the conclusion of the stage. In the above example, the “NDA/PLA Filed” milestone is awarded at the successful conclusion of the Phase III development stage. If the development program completes Phase III successfully in the research region, the R&D company will earn $3 million before starting the NDA filing stage.

Expense Reimbursements

Usually, the client company agrees to underwrite all or a portion of the R&D company's development costs as part of an alliance. If expense reimbursements are specified for a development stage, the client company will pay the specified portion of the expenses when the R&D company incurs them. Development expenses are expressed in millions of dollars per year, so the evaluation system uses the rate-based method when it calculates the NPV of the expenses and their reimbursements.

The evaluation system provides an Expense Reimbursements worksheet 156 (see FIG. 10) to describe this type of structure in the alliance model. Expense Reimbursement worksheet 156 is accessible via Deal Overview worksheet 140. As shown in FIG. 10, Expense Reimbursement worksheet 156 includes entry fields for each region corresponding to the various development stages. If a region has not been included in the alliance, its entry fields will be inactive.

The client company can underwrite a percentage of the R&D company's development costs for any development stage in any region. To express an expense reimbursement in Expense Reimbursement worksheet 156, the user locates the field for the development stage that will have its costs underwritten and enters the percentage of the costs that will be borne by the client company.

In a simple license agreement, the client company pays all the development costs from the date of signing onward. Expense Reimbursement worksheet 156 defaults to this case; by default, every field on Expense Reimbursement worksheet 156 is preset to 100%.

As a second example, in a worldwide co-development deal suppose the client company agrees to underwrite 75% of the worldwide clinical trials costs. To model this alliance, the user opens Expense Reimbursement worksheet 156 and enters 75% in the Phase I, Phase II, and Phase III fields for all three regions. All remaining fields are set to 0% in this example.

Royalty Payments The alliance structures described above relate to pre-commercial arrangements. Client companies typically use the pre-commercial structures to compensate R&D companies for post-commercial rights to a drug when it arrives on the market. Post-commercial structures describe the different ways that alliance partners share in the success of a developed drug. The most common post-commercial alliance structure is a royalty agreement. Under this arrangement, the client company markets the drug and keeps any profits after returning a percentage of the net sales to the R&D company. The evaluation system utilizes a Royalty Payments worksheet 158 to describe royalty agreements (see FIG. 11). Royalty Payments worksheet 158 is accessible via Deal Overview worksheet 140.

Royalty rates by are entered by region in Royalty Payments worksheet 158. If the fields for a region are inactive, that region has not been included in the alliance. For each region, the user enters the percentage of the net sales that will be returned to the R&D company. This royalty rate can change if the drug meets annual or cumulative sales thresholds. Accordingly, the worksheet includes a trio of selectable buttons for each region; the user selects one of these buttons to determine whether sales thresholds will be included in the royalty agreement. If the user selects the No Threshold option, only one active field will be available for entering a royalty rate. In this case, the evaluation system will use a single percentage value when it calculates the size of the royalty payment on all sales in the region. If the user chooses either the Cumulative Threshold option or the Annual Threshold option, five royalty rate and threshold fields will become active.

When cumulative royalty thresholds are included in an alliance, the royalty rate changes as the drug meets lifetime sales goals. For the first commercial sales, the evaluation system will calculate the royalty payment using the first of the five possible royalty rates. As time progresses, the evaluation system calculates a running total of all sales in the region when they accumulate. Once the lifetime gross sales reaches the first threshold value in the list, the evaluation system begins using the second rate to calculate royalties. This continues until one of three conditions is met. If a threshold value is zero, the corresponding rate is considered the final rate and the evaluation system will use no other rate for the remainder of the product's lifetime. If the evaluation system reaches the fifth rate in the list, it will be the final rate used for the royalty calculation. Finally, if the drug leaves the market without reaching one of the thresholds, the next rate in the list will never be used.

Annual thresholds behave like cumulative thresholds, except that the threshold values are compared to the annual net sales rather than the lifetime net sales. At the beginning of each year, the evaluation system starts a new running total and reverts to using the first royalty rate in the list until sales exceed the first threshold value.

As an example royalty structure, assume that a drug will be developed in the United States and marketed in the United States, Europe, and Asia under separate royalty terms in each region. The R&D company will receive a straight 7% royalty in the United States. In Europe, the rate will start at 7% and will climb to 10% for any sales beyond $300 million in a year. The royalty rate in Asia will start at 6%. If lifetime sales climb to $800 million, the royalty rate will increase to 8%. Finally, if the cumulative Asian sales hit $1.6 billion, the R&D company will earn 10% royalties.

In the Research Region area 236, the user will select the No Threshold option and enter 7% in the only active rate field. In the Second Region area 238, representing Europe, the user will select the Annual Threshold option, enter 7% in the first rate field, enter $300 million in the first threshold field, and enter 10% in the second rate field. Finally, the user will select the Cumulative Threshold option in the Third Region area 240, which represents Asia. The user will enter 6% in the first rate field, $800 million in the first threshold field, 8% in the second royalty rate field, $1,600 million in the second threshold field, and 10% in the third royalty rate field.

The R&D company receives payment from the client company whenever sales are booked in a region where royalties are specified. The client company keeps the remaining profits. Because sales arrive in millions of dollars per year, the evaluation system uses the rate-based NPV calculation for the both companies' revenues. NPV calculations are time-dependent, so the evaluation system must be aware of when rate-increasing thresholds are met. For instance, if an annual royalty threshold is crossed at $100 million and the drug generates $400 million for the year, the evaluation system books revenues at the first royalty rate for the first three months of the year and the second rate for the remaining nine months.

Profit Split

A second way for two alliance partners to share in the success of a drug is through a profit split agreement. In a profit split agreement, one or both of the partners market the drug and the partners divide the profit according to a formula. The evaluation system provides a Profit Split worksheet 160 (see FIG. 12), which is accessible via Deal Overview worksheet 140. Profit Split worksheet 160 allows a user to create different profit split arrangements in each region. If a region hasn't been included in your alliance model, its corresponding fields in the worksheet will be inactive.

For each region, the user defines the profit split agreement by specifying the percentage of the profit that the R&D company will receive. This percentage is entered in a “Take” field 252, 254. The size of the profit split can evolve with time. Accordingly, a “# Splits” selection menu 256 allows the user to designate the number of times the division of profits will change during product's lifetime. When the number of profit splits are increased, additional “Start,” “Finish,” and “Take” fields will become active. With the exception of the final division, the user enters a start and finish time for each profit split. These time values are in years, and they are relative to the start of commercial sales. For the interval between the first start time and the first finish time, the R&D company will get the percentage of profit contribution specified in the first “Take” field 252 and the client company will receive the remainder. Between the second start and finish times, the R&D company receives the percentage specified in the second “Take” field 254. This continues until the product outlives the final finish time. After the final finish time, the R&D company earns the revenues specified by the final take value.

As an example, suppose two alliance partners agree to equally share all North American profits for the first five years a drug is on the market. Thereafter, the R&D company will keep 70% of the profits from the drug and the client will take the remaining 30%. First, the development and sales assumption settings for one of the three regions should reflect the assumptions for North American development costs and revenues. Next, the North American region and the profit split deal structure are selected using the appropriate checkboxes in Deal Overview worksheet 140 (see FIG. 2). The user then increases the number of splits in “# Splits” selection menu for the North American region to “Two.” In addition, the user enters 0 years in the “Start” field, 5 years in the “Finish” field, and 50% in first “Take” field 252 for the first profit split. For the second split, the user enters 70% in second “Take” field 254.

Both companies will share the profit contribution or loss as long as an active profit split exists. The profit contribution for a period of time is determined by multiplying the contribution margin and the total sales. Because sales arrive in millions of dollars per year, the evaluation system uses a rate-based NPV calculation.

Supply Agreement

Supply agreements are a third way that alliance partners can share the benefit of a successful drug. In a typical supply agreement, the R&D company manufactures the drug itself or through a third party and then supplies it to the client company at an agreed price. The evaluation system includes a Supply Agreement worksheet 162 (see FIG. 13) that allows a user to include a supply agreement in the alliance model. Supply Agreement worksheet 162 is also accessible via Deal Overview worksheet 140. Using Supply Agreement worksheet 162, the user can define separate supply agreements for each region. If the fields for a region are inactive, the region has not been included in the alliance model.

The user can express the transfer price in a region as a percentage of either the product's sales price or its manufacturing cost. If the “Net Sales Based” option is selected, then the user should enter the percentage of the sales price that will be paid to the R&D company for supplying the drug. This percentage should be less than 100%, or the client company is guaranteed to lose money on every sale. If the “CoGS Based” option is selected, then the user will enter the percentage of the drug's manufacturing cost that will be returned to the R&D company. This value must be greater than 100% or the R&D company will lose money on each sale.

As an example, suppose that in an alliance, the R&D company will supply a product to the client company at 30% of the sales price in North America and at 150% of the manufacturing costs in Europe and Asia. To model this alliance, the user includes the supply agreement structure and all three regions in the alliance model (the user should have previously defined the three regions as though they are North America, Europe, and Asia in the Development Assumptions worksheets and Sales Assumptions worksheets). In Supply Agreement worksheet 162, the user selects the “Net Sales Based” option for the region corresponding to North America and the “CoGS Based” option for the remaining two regions. Finally, the user enters 30% in a “Rate” field for the North American region, and 150% in second and third “Rate” fields for Europe and Asia, respectively.

The R&D company receives payment whenever sales are booked by the client company. For a net sales-based transfer agreement, the client company simply pays the R&D company the specified portion of its sales. However, the R&D company must pay the cost of manufacturing the drug. This value is expressed as a percentage of the sales price, and it is set in the appropriate “Rate” field on Supply Agreement worksheet 162. Note that if a net sales-based supply agreement has a rate lower than the “CoGS” value, the R&D company will always lose money on every unit sold. For example, if the R&D company receives 30% of the sales price for goods sold in North America as specified in the “Rate” field, but the value in the “CoGS” field is 40%, the R&D company will spend more money manufacturing the drug than it will receive from the client company.

The evaluation system uses this same “CoGS” value when it calculates the transfer price in a CoGs-based supply agreement. First, the evaluation system multiplies the value specified in the “CoGS” field by the net sales for a period to determine the total manufacturing cost for that period. The R&D company will receive this amount times the rate specified in the “Rate” field. The R&D company will have to pay the drug's manufacturing costs, so if the rate is less than 100%, the R&D company will lose money on every sale.

It is worth noting that, as with pre-commercial alliance structures, the user can combine different post-commercial alliance structures in a single simulation. For example, the user could easily model an alliance having a profit spit agreement in the United States, a supply agreement and royalty payments in Europe, and a simple royalty agreement in Asia. This ability to combine the various optional deal structures gives the user the flexibility to model very complex alliances.

Running the Model

As described above, the financial terms of a partnered drug development program are initially defined using the various worksheets and data entry panels provided by the evaluation system. First, the development program's cost structure is specified in the Development Assumptions worksheets. Then, the potential market performance of the new drug is described. Finally, the terms of the strategic alliance are “superimposed” over the assumptions using the various deal structure elements identified in Deal Overview worksheet 140. Ultimately, the evaluation system creates an NPV distribution for the partnered drug development program. Global parameters used during the simulation can be entered in Run worksheet 164 (see FIG. 14).

Environmental Settings

Environmental settings describe the context in which the model is run. The environmental settings function as parameters that affect the framework used to analyze the specific partnered development program.

One set of environmental settings governs the probability of successfully completing each development stage during the simulation. These settings are arranged in a column along the left side of Run worksheet 164 under the heading “Likelihood of Success.” Each of the fields in the column corresponds to one of the designated development stages. The values in the fields range between 0 and 100, and they represent the percentage of times the drug will successfully conclude the corresponding development stage. For instance, if the drug is in the validation stage during a cycle, the evaluation system will determine whether development continues to the pre-clinical stage by comparing a random number to the value in the “Validation” field in Run worksheet 164. If the value in the Validation field is 75, the drug will successfully start the pre-clinical development stage in 75 percent of the cases where the drug has already reached the validation stage.

Another environmental setting identifies the development stage that has been reached in the research region at the start of the simulation. A “Current Development Stage” selection menu 270 contains an entry for each development stage. Suppose that the development program has already reached Phase I clinical trials in the United States at the time the alliance is negotiated. If the United States is the research region in the simulation, then the “Phase I” item would be selected in the “Current Development Stage” selection menu 270. The evaluation system ignores sunk costs, so development costs and partnering events from the four previous stages in the research region would not be included in the NPV calculations. However, development in the second and third regions is usually set up to lag behind development in the research region. This means that development in the second and third regions could be in an earlier development stage, such as the pre-clinical stage, at the start of the simulation. Even if the “Current Development Stage” selection menu 270 is set to Phase I, development expenses and partnering revenues from earlier development stages in the second and third regions could be included the NPV calculation for a cycle.

A “Rate” field 266 contained in Run worksheet 164 represents the cost of capital that the evaluation system will use in the NPV calculations. The cost of capital represents the rate of return a company could earn by investing its cash in an alternative investment of equivalent risk. In an NPV calculation, money earned or spent in the future is discounted by this annual rate. Usually, higher risk investments are evaluated with higher costs of capital. An estimated 12 to 15 percent cost of capital is typically used when modeling biotechnology industry strategic alliances. Although drug development is very risky, the evaluation system explicitly captures most of the risk in the probability functions for delay, failure, and commercial success. The recommended rates reflect the cost of capital for a major pharmaceutical company rather than for a young biotechnology startup company because a drug development program is typically partnered throughout its later stages. The evaluation system compounds the cost of capital continuously, rather than annually, because the former results in greater computational flexibility.

The final environmental setting in Run worksheet 164 is represented by an “Iterations” field 268. When the evaluation system executes, it repeatedly creates random drug development programs and calculates and stores their NPVs. Each of these cycles is an iteration of the model, and “Iterations” field 268 determines the number of development programs that will be created when the simulation executes. For example, if 5,000 is entered as a value in “Iterations” field 268, then the evaluation system will randomly create and value 5,000 drug development programs using the same settings and parameters. The result will be a distribution containing 5,000 NPVs. When the evaluation system is instructed to perform a greater number of iterations, the output distribution more accurately reflects the theoretically perfect analytic solution. This increase in accuracy is proportional to the square root of the increase in iterations. Thus, if the user wants the results to be twice as accurate, then the evaluation system must run at least four times as many iterations.

Three Perspectives

Once all of the necessary parameters have been entered, the evaluation system can begin the simulation; the user simply presses a “Run” button 272. When the evaluation system has finished executing, a “Graph” button 276 will become active, and new statistical results will appear in the nine boxes in the lower left corner of Run worksheet 164.

After the evaluation system executes, it places the results in nine fields that are arranged in a three-by-three grid. Each row in the grid represents a different perspective of the valuation of the drug development program. A first row displays results for the unpartnered drug development program. A second row shows NPV statistics generated from the R&D company's cash stream for the partnered development program. Finally, a third row reveals NPV statistics for the partnered program as viewed by the client company.

When the evaluation system executes, it randomly builds a drug development program for each iteration specified in “Iterations” field 268. The evaluation system actually calculates three NPVs in each cycle. The first NPV calculation ignores any strategic alliance created in Deal Overview worksheet 140. The development costs and sales assumptions are included in the calculation as if the R&D company is developing and marketing the drug without any help from a partner. This starting proposition describes the value of the unpartnered drug development program. The system collects NPVs for the unpartnered program into a distribution and extracts some statistics. The NPV statistics for the unpartnered development program appear in the first row.

The second NPV that the evaluation system calculates in an iteration evaluates the partnered drug development program from the R&D company's point-of-view. During development, the R&D company still pays all the development costs, but it simultaneously receives revenue from the client company as the client fulfills the pre-commercial terms of the strategic alliance. This reduces the size of the total cash outflow for the R&D company during the drug's development and increases the program's NPV. If the drug arrives at market in a given simulation cycle, the R&D company is obligated to share the benefit with the client company. This typically reduces the NPV of a successful program for the R&D partner. The evaluation system calculates the R&D company's NPV for each iteration and collects the NPVs into a distribution. Statistics from this distribution appear in the second row. The user can compare the “R&D Company” statistics to the “Unpartnered NPV” statistics to gauge the likely effect of an alliance for the R&D partner.

Finally, the evaluation system calculates an NPV for the partnered drug development program from the client company's perspective in each iteration. In this case, the system monitors pre-commercial cash flow from the client company to the R&D company. This outward cash flow becomes a negative NPV for the client company if the drug fails to arrive on the market. However, if the drug is successfully commercialized during an iteration, the client company will share in the profits as prescribed in Deal Overview worksheet 140. This increases the NPV for that iteration. The system also collects all the client company NPVs into a distribution and extracts some statistics. These statistics appear in the third row. The “Client Company” statistics indicate the size of the client's stake in the drug development effort.

Three Statistics

When the evaluation system runs, it builds three NPV distributions that describe the value of the drug development program from three different points-of-view. These distributions illustrate the relative probability of achieving various NPVs. The system extracts the most important statistics from these distributions and places them in the nine result fields on Run worksheet 164. The result fields are arranged in a three-by-three grid and each column of the grid displays a different statistical result for the three NPV distributions.

The left-most column in the grid reports the mean value of the distributions. A portfolio containing a large number of drug development programs is worth the sum of the average values of all the programs. Although the mean is the best indicator of a drug development program's value, any of the NPVs in the distribution, including the very bad ones, have a chance of occurring. Consequently, the mean value provides no estimate of the exposure to this risk. The sample NPV distribution graph shown in FIG. 18 illustrates this concept.

FIG. 18 shows an example NPV distribution for an unpartnered drug development program. The distribution groups randomly generated NPVs into different $10 million-wide ranges. The horizontal axis shows the beginning and end of each range in millions of dollars. The vertical axis shows the number of iterations that achieved an NPV within each range. For example, the tallest feature 1802 in the example distribution shows that for almost 800 iterations, the drug development program had an NPV between negative $10 million and negative $20 million.

The prominent feature 1804 to the left of the sample distribution primarily represents failed attempts to develop the drug. In these cases the program bums cash during development but never recovers money on the market. The resulting NPVs have negative values. This feature is relatively narrow because the worst case NPV is only a $70 million loss. The broad and flat feature 1806 on the right side of the example distribution represents those cases where the drug successfully arrives on the market. The feature is broad compared to the feature that represents the losing scenarios because if the drug is successful it could be worth as much as $580 million.

As shown, the sample distribution of FIG. 18 has a mean value of $58.8 million. This is the average value that would be expected if a company were free to repeatedly develop the drug. However, in the real world a company usually only gets one chance to develop a particular drug and the drug will either succeed or fail. A pharmaceutical company that shares in the development of a large number of drugs is essentially repeatedly developing drugs. In this case, the pharmaceutical company can expect to achieve the sum of the average values of each drug in the portfolio, even though some particular drugs may be spectacular failures and others may be phenomenal successes.

The sample distribution illustrates the relative probability of achieving various NPVs. If a higher number of counts are recorded in an NPV range, it means that an NPV in that range is more likely to occur. Although the mean value of the distribution is $58 million, the lack of counts in the $50 million to $60 million range indicates that there is no chance of this exact value occurring. The height of the negative peak at the left of the distribution indicates that the most likely outcome is a failed drug with a negative NPV. Despite this fact, the mean value of the distribution is a healthy positive value because the distribution of successful scenarios extends to very high positive values.

Although the distribution's mean value is a good indication of a drug development program's value, it may not always be a good statistic that illustrates the exposure to money-losing scenarios. The distribution's median is a good indicator of this risk. By definition, one half of the NPVs in the distribution are less than the median value and the other half are greater. For example, suppose a distribution contains 1,000 NPVs. If the NPVs are sorted from smallest to largest, the 500^{th} value in the sorted list will be the median. By this definition, one could not expect that a randomly selected NPV would be either higher or lower than the median value. After the evaluation system executes, it reports the median value for each of the three distributions it develops in the center column of the nine result fields.

In the illustrated example, the median value is negative $23.3 million, which differs significantly from the mean value. A biotechnology company with a single product in its pipeline should probably be concerned to see that the most likely NPV for the drug is a large negative amount, even if the mean value is positive. Of course, the company can mitigate this risk by joining a strategic alliance.

The following example of a simple alliance illustrates how an R&D company can mitigate its risk. Suppose that the client company pays the R&D company $10 million upon signing an agreement. Under the agreement, if the R&D company successfully brings its drug to the market, the R&D company will pay the client company $30 million (adjusted for time). The R&D company gets the $10 million even if the drug is a failure. In all the cases where the development program fails, the program's NPV will increase by $10 million. This has the effect of shifting all the points in the tall peak 1804 shown in FIG. 18, including the median, to the right by $10 million. The change from negative $23.3 million to negative $13.3 million for the median value of the NPV distribution reflects the degree to which the alliance mitigates the R&D company's risk.

Of course the R&D company pays a price for this risk mitigation. The $30 million dollar payment it makes to the client reduces the NPV for every scenario in which the drug is developed successfully. This payment shifts the broad peak 1806 in the original NPV distribution to the left, and it reduces the distribution's mean value. (Technically, the $10 million payment increases the mean and the $30 million payment decreases it. The net result could be either an increase or a decrease, depending on the ratio of successful to unsuccessful deals. However, only a poorly managed client company would sign an agreement that increases both the R&D company's median and mean values.) The client company can construct a simple NPV distribution from this proposed alliance. There will be a tall peak at negative $10 million for all the cases in which the client pays the R&D company $10 million and the drug fails to arrive on the market. A smaller peak at $20 million corresponds to the successful development programs. This distribution will have a mean and median value. If the client company has a large number of alliances with R&D companies, it should not be overly concerned with the median value. The client should be satisfied as long as the mean value is positive and the development program has a reasonable chance of being successful.

In fact, both parties will be satisfied if the actual NPV of a partnered drug development program is $0. In calculating an NPV, cash outlays and inflows are discounted at some rate over the lifetime of the development program. If the NPV of a development program is $0 it means that the cash inflows were large enough to offset the outlays and the discounting. In other words, if a development program's NPV is $0, it successfully earned back the cost of capital, which is defined as being an acceptable rate of return.

It is easy for the evaluation system to calculate the likelihood of success for the unpartnered, R&D, and client NPV distributions. For each distribution, the system simply counts the number of positive NPVs and divides by the total number of cycles. The system displays the resulting percentage in the third column of the nine result fields. If the probability of success is 10% in the “Unpartnered NPV” row and 40% in the “R&D Company” row for a partnered drug development program, the alliance has the desired effect of increasing the R&D company's odds of survival.

Graphing the Results

As mentioned above, each time the evaluation system executes it creates three NPV distributions. The evaluation system includes a powerful graphing feature that can be used to examine these distributions. After the evaluation system executes, it stores the resulting NPV distributions in memory and it activates “Graph” button 276 on Run worksheet 164 (see FIG. 14). When the user selects “Graph” button 276, the evaluation system generates a graph showing the three distributions. FIG. 19 illustrates example graphs corresponding to such distributions.

The horizontal axis of each distribution is divided into a number of bins. For a given distribution, each bin represents a certain range of dollar amounts. The evaluation system calculates the bin width to display a given distribution at its highest resolution, so the width may vary from distribution to distribution.

Each bin represents a range of NPV values. Before the evaluation system generates the graphical representation of the distribution, it sorts the NPVs and counts the number that fall within each bin. For example, one bin may represent NPV values between $5 million and $10 million. The evaluation system will count the number of randomly generated NPVs having values that fall within this range. The scale of the vertical axis is related to the number of counts that fall in each bin. Bins containing a higher number of NPV counts will climb higher up the vertical scale.

Because the NPVs are randomly generated, the distribution maps out the relative likelihood of different NPVs occurring. A bin containing a high number of counts represents the relatively high chance of achieving an NPV in the corresponding NPV range.

The graphs include a valuable analytical tool. Two red cursors 1902, 1904 are initially positioned along the left edge of each distribution. The user can move the cursors by clicking on them and dragging them horizontally across the displayed distribution. As a cursor is moved, the system displays its position along the horizontal axis in millions of dollars. At the same time, a red probability indicator 1906 at the top of each distribution will display the probability of achieving a NPV between the positions of the two cursors. For example, if one cursor is positioned at $0 and the other is at $100 million, probability indicator 1906 will indicate the odds of achieving an NPV between those two values.

Finally, the evaluation system identifies the mean and median values of each distribution, preferably using different colors or shadings in the graphs.

Comparing Results

The evaluation system may also be configured to allow the user to compare the results of any number of different alliance structures. The comparison feature may utilize reports, graphs, charts, or any suitable format that conveys “side-by-side” data. For example, the evaluation system can generate NPV statistics for a first proposed development program, allow the user to modify any number of simulation parameters (such as deal terms, development assumptions, sales assumptions, or the like), and generate corresponding NPV statistics for the modified program. The results of the two simulations can be displayed to the user in any convenient manner, thus allowing the user to immediately observe the effect of the modifications.

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as expressed in the following claims.

What is claimed is:

1. A computerized method for evaluating the value of a proposed development program for a product, said method comprising:
defining an alliance structure between a first entity responsible for the development of said product and a second entity;
obtaining a set of development cost assumptions for said proposed development program;
obtaining a set of sales assumptions representing sales of said product;
randomly determining, for each of a plurality of iterations, the net present value (NPV) of said proposed development program to thereby obtain a plurality of NPVs, each of said plurality of NPVs being determined in accordance with said alliance structure, said set of development cost assumptions, said set of sales assumptions, and at least one probabilistic function; and
performing an economic analysis of said plurality of NPVs.

2. A method according to claim 1, wherein said economic analysis is based upon a statistical distribution of said plurality of NPVs.

3. A method according to claim 1, wherein said at least one probabilistic function determines whether said proposed development program results in a successfully developed product.

4. A method according to claim 1, further comprising the step of generating an output indicative of an economic value of said proposed development program.

5. A method according to claim 1, wherein:
said alliance structure includes at least one component corresponding to a first region and at least one component corresponding to a second region; and
each of said plurality of NPVs includes a first economic contribution related to said first region and a second economic contribution related to said second region.

6. A method according to claim 1, wherein:
said set of development assumptions includes at least one component corresponding to a first region and at least one component corresponding to a second region; and
each of said plurality of NPVs includes a first economic contribution related to said first region and a second economic contribution related to said second region.

7. A method according to claim 1, wherein:
said set of sales assumptions includes at least one component corresponding to a first region and at least one component corresponding to a second region; and
each of said plurality of NPVs includes a first economic contribution related to said first region and a second economic contribution related to said second region.

8. A method according to claim 1, wherein at least one of said plurality of NPVs is calculated in accordance with the following relationship: NPV=Pe^{-rt}, where P represents a lump sum payment amount, r represents a periodic cost of capital, and t represents a number of periods before payment.

9. A method according to claim 1, wherein at least one of said plurality of NPVs is calculated in accordance with the following relationship:
$$NPV = {\int }_{T1}^{T2} {Ae}^{- rt} ⅆ t = \frac{A}{r} ( {ⅇ}^{- rT1} - {ⅇ}^{- rT2} ) ,$$
where A represents a constant cash flow rate, r represents a periodic cost of capital, T1 represents a start of a time period during which the cash flow occurs, and T2 represents an end of said time period.

10. A method according to claim 1, further comprising the step of adjusting a previously-calculated NPV in response to a time offset to calculate an adjusted NPV, said adjusted NPV being calculated in accordance with the following relationship: NPV₂=NPV₁(e^{-rt}), where NPV₂ represents said adjusted NPV, NPV₁ represents said previously-calculated NPV, r represents a periodic cost of capital, and t represents said time offset.

11. A computer program, embodied on a computer-readable medium, for evaluating the value of a proposed development program for a product, said computer program comprising:
a first program code segment containing instructions for defining an alliance structure between a first entity responsible for the development of said product and a second entity;
a second program code segment containing instructions for obtaining a set of development cost assumptions for said proposed development program;
a third program code segment containing instructions for obtaining a set of sales assumptions representing sales of said product;
a fourth program code segment containing instructions for randomly determining, for each of a plurality of iterations, the net present value (NPV) of said proposed development program to thereby obtain a plurality of NPVs, each of said plurality of NPVs being determined in accordance with said alliance structure, said set of development cost assumptions, said set of sales assumptions, and at least one probabilistic function; and
a fifth program code segment containing instructions for performing an economic analysis of said plurality of NPVs.

12. A computerized method for evaluating the value of a proposed development program for a product, said method comprising:
obtaining a set of development cost assumptions corresponding to a number of product development stages;
determining, using a probabilistic function, a successfully completed product development stage for said proposed development program;
computing a time duration for said successfully completed product development stage; and
calculating a net present value (NPV) for said proposed development program in response to said set of development cost assumptions and in response to said time duration.

13. A method according to claim 12, wherein:
said obtaining step is performed by a client computer system; and
said client computer system obtains said set of development cost assumptions from a server computer system that communicates with said client computer system via a communication link.

14. A method according to claim 12, further comprising the step of creating said set of development cost assumptions in response to empirical product data.

15. A method according to claim 12, wherein said computing step computes said time duration using a second probabilistic function.

16. A method according to claim 12, further comprising the step of repeating said determining step, said computing step, and said calculating step for a number of iterations.

17. A method according to claim 12, farther comprising the step of obtaining a set of sales assumptions representing sales of a developed product.

18. A method according to claim 17, wherein said set of sales assumptions represents a flat sales characteristic with respect to time.

19. A method according to claim 17, wherein said set of sales assumptions represents a variable sales characteristic with respect to time.

20. A method according to claim 17, further comprising the step of evaluating, with said set of sales assumptions, potential sales of said product.

21. A method according to claim 20, wherein:
said number of product development stages includes a final product development stage; and
said evaluating step is performed if said successfully completed product development stage represents said final product development stage.

22. A method according to claim 20, wherein said evaluating step is performed in accordance with a second probabilistic function.

23. A method according to claim 17, further comprising the step of creating said set of sales assumptions in response to empirical product data.

24. A method according to claim 12, wherein said calculating step comprises the step of processing projected costs and income associated with said proposed development program.

25. A method according to claim 24, wherein said calculating step further comprises the step of processing projected income associated with sales of said product.

26. A computer program, embodied on a computer-readable medium, for evaluating the value of a proposed development plan for a product, said computer program comprising:
a first program code segment containing instructions for obtaining a set of development cost assumptions corresponding to a number of product development stages;
a second program code segment containing instructions for determining, using a probabilistic function, a successfully completed product development stage for said proposed development program;
a third program code segment containing instructions for computing a time duration for said successfully completed product development stage; and
a fourth program code segment containing instructions for calculating a net present value (NPV) for said proposed development program in response to said set of development cost assumptions and in response to said time duration.

27. A computerized method for evaluating the value of a proposed development program for a product, said method comprising:
obtaining a set of development cost assumptions for said proposed development program;
repeatedly calculating a net present value (NPV) for said proposed development program to obtain a plurality of NPVs, each of said plurality of NPVs being calculated in response to said set of development cost assumptions and in response to at least one probabilistic function; and
generating a statistical representation of said plurality of NPVs.

28. A method according to claim 27, wherein said generating step generates a mean NPV for said plurality of NPVs.

29. A method according to claim 27, wherein said generating step generates a median NPV for said plurality of NPVs.

30. A method according to claim 27, wherein said generating step generates an NPV distribution for said plurality of NPVs.

31. A method according to claim 27, wherein said at least one probabilistic function determines whether said proposed development program results in a successfully developed product.

32. A method according to claim 27, further comprising the step of determining, in response to empirical product development data, whether said proposed development program results in a successfully developed product.

33. A method according to claim 27, wherein said at least one probabilistic function determines the duration of said proposed development program.

34. A method according to claim 27, further comprising the step of determining, in response to empirical product development data, the duration of said proposed development program.

35. A method according to claim 27, further comprising the step of defining an alliance structure between a first entity and at least one other entity, said first entity being responsible for the development of said product, wherein each of said plurality of NPVs is further calculated in response to said alliance structure.

36. A method according to claim 35, wherein said alliance structure is defined such that said at least one other entity provides economic support to said first entity during said proposed development program.

37. A method according to claim 35, wherein said alliance structure is defined such that said at least one other entity obtains an economic benefit derived from sales of said product.

38. A method according to claim 35, wherein said defining step defines a guaranteed payment schedule that represents guaranteed payments from said other entity to said first entity.

39. A method according to claim 38, wherein said guaranteed payment schedule identifies a development program stage that determines when guaranteed payments are made.

40. A method according to claim 35, wherein said defining step defines a sponsored research schedule that represents sponsored research benefits given to said first entity.

41. A method according to claim 40, wherein said sponsored research schedule identifies at least one time period during which said sponsored research benefits are given to said first entity.

42. A method according to claim 35, wherein said defining step defines a milestone payment schedule that represents milestone payments from said other entity to said first entity.

43. A method according to claim 42, wherein said milestone payment schedule identifies a plurality of product development stages and a corresponding plurality of milestone payments.

44. A method according to claim 35 wherein said defining step defines an expense reimbursement schedule that represents expense reimbursements given to said first entity.

45. A method according to claim 44, wherein said expense reimbursement schedule identifies a plurality of product development stages and a corresponding plurality of expense reimbursement percentages.

46. A method according to claim 35, wherein said defining step defines a royalty payment schedule including at least one royalty rate.

47. A method according to claim 46, wherein said royalty payment schedule identifies a number of threshold royalty amounts corresponding to a like number of royalty rates.

48. A method according to claim 46, wherein said royalty payment schedule identifies a number of time periods corresponding to a like number of royalty rates.

49. A method according to claim 35, wherein said defining step defines a profit splitting arrangement between said first entity an said other entity.

50. A method according to claim 49, wherein said profit splitting arrangement identifies at least one profit splitting percentage.

51. A method according to claim 50, wherein said profit splitting arrangement identifies at least two profit splitting percentages and at least one time period during which one of said at least two profit splitting percentages is effective.

52. A method according to claim 50, wherein said profit splitting arrangement identifies at least two profit splitting percentages and at least one sales threshold corresponding to one of said at least two profit splitting percentages.

53. A method according to claim 35, wherein said defining step defines a supply agreement.

54. A method according to claim 53, wherein said supply agreement identifies a portion of net sales returned to said first entity.

55. A method according to claim 53, wherein said supply agreement identifies a percentage of manufacturing costs returned to said first entity.

56. A method according to claim 35, wherein said step of defining an alliance structure is responsive to historical alliance data.

57. A method according to claim 27, further comprising the step of obtaining a set of sales assumptions that represents sales of a product successfully developed under said proposed development program, wherein each of said plurality of NPVs is further calculated in response to said set of sales assumptions.

58. A method according to claim 57, wherein said at least one probabilistic function determines a simulated sales scenario based upon said set of sales assumptions.

59. A method according to claim 58, wherein said simulated sales scenario represents a flat sales characteristic with respect to time.

60. A method according to claim 58, wherein said simulated sales scenario represents a variable sales characteristic with respect to time.

61. A method according to claim 57, further comprising the step of determining a simulated sales scenario based upon said set of sales assumptions and based upon empirical product sales data.

62. A computer program, embodied on a computer-readable medium, for evaluating the value of a proposed development program for a product, said computer program comprising:
a first program code segment containing instructions for obtaining a set of development cost assumptions for said proposed development program;
a second program code segment containing instructions for repeatedly calculating a net present value (NPV) for said proposed development program to obtain a plurality of NPVs, each of said plurality of NPVs being calculated in response to said set of development cost assumptions and in response to at least one probabilistic function; and
a third program code segment containing instructions for generating a statistical representation of said plurality of NPVs.
